(19) United States
(12) Patent Application Publication
(10) Pub. No.: US 2016/0004036 A1
(43) Pub. Date: Jan. 7, 2016

(54) IMAGING LENS AND IMAGING APPARATUS

(71) Applicant: FUJIFILM Corporation, Tokyo (JP)

(72) Inventor: Taro ASAMI, Saitama-ken (JP)

(21) Appl. No.: 14/848,366

(22) Filed: Sep. 9, 2015

Related U.S. Application Data
(63) Continuation of application No. PCT/JP2013/007645, filed on Dec. 26, 2013.

(30) Foreign Application Priority Data
Mar. 12, 2013 (JP) 048745/2013

(51) Int. Cl. G02B 13/00; G02B 9/34

(52) U.S. Cl. CPC G02B 13/004; G02B 9/34

(57) ABSTRACT

An imaging lens consists of four lenses of, in order from the object side, a negative first lens, a negative second lens, a positive third lens, and a positive fourth lens. The following conditional expressions are satisfied:

0.22<Nd3−Nd2 (1);

1.2<D3/f (2); and

−0.4<(R3+R4)/(R3−R4)<1.0 (7-5), where
Nd3 is a refractive index of the material of the third lens for d-line,
Nd2 is a refractive index of the material of the second lens for d-line,
D3 is a center thickness of the second lens,
f is a focal length of an entire system
R3 is a paraxial curvature radius of an object-side surface of the second lens, and
R4 is a paraxial curvature radius of an image-side surface of the second lens.

### CROSS-REFERENCE TO RELATED APPLICATIONS

This application is a Continuation of PCT International Application No. PCT/JP2013/007645 filed on Dec. 26, 2013, which claims priority under 35 U.S.C §119(a) to Japanese Patent Application No. 2013-048745 filed on Mar. 12, 2013. Each of the above applications is hereby expressly incorporated by reference, in its entirety, into the present application.

### BACKGROUND

The present disclosure relates to an imaging lens and an imaging apparatus, and particularly to an imaging lens appropriate for use in an in-vehicle camera, a camera for a mobile terminal, a surveillance camera or the like using an imaging device, such as a CCD (Charge Coupled Device) and a CMOS (Complementary Metal Oxide Semiconductor), and an imaging apparatus including the imaging lens.

In recent years, the size of an imaging device, such as a CCD and a CMOS, became very small, and the resolution of the imaging device became very high. Consequently, the size of the body of imaging equipment including such an imaging device became smaller. Therefore, reduction in the size of an imaging lens to be mounted on the imaging equipment is also needed in addition to high optical performance of the imaging lens. Meanwhile, lenses mounted on an in-vehicle camera, a surveillance camera and the like need to be configurable at low cost in addition to being small-sized. Further, the lenses need to have a wide angle of view and high performance.

Japanese Unexamined Patent Publication No. 2008-242040 (Patent Document 1), Japanese Unexamined Patent Publication No. 2011-065132 (Patent Document 2) and Japanese Unexamined Patent Publication No. 2011-158868 (Patent Document 3) propose imaging lenses, as an imaging lens to be mounted on an in-vehicle camera. The imaging lens consists of four lenses of, in order from the object side, a negative lens, a negative lens, a positive lens and a positive lens.

### SUMMARY

Meanwhile, requirements for imaging lenses mounted on an in-vehicle camera, a surveillance camera and the like have become tougher every year, and further reduction in cost, a wider angle of view and higher performance are needed.

In view of the foregoing circumstances, the present disclosure provides an imaging lens that can achieve a lower cost, a wider angle of view and higher performance, and an imaging apparatus including the imaging lens.

A first imaging lens of the present disclosure consists of, in order from the object side, a first lens having negative refractive power, a second lens having negative refractive power, a third lens having positive refractive power, and a fourth lens having positive refractive power. Further, the following conditional expressions are satisfied:

0.22<Nd3−Nd2 (1); and

1.2<D3/f (2), where

Nd3 is a refractive index of the material of the third lens for d-line,

Nd2 is a refractive index of the material of the second lens for d-line,

D3 is a center thickness of the second lens, and

f is a focal length of an entire system.

A second imaging lens of the present disclosure consists of, in order from the object side, a first lens having negative refractive power, a second lens having negative refractive power, a third lens having positive refractive power, and a fourth lens having positive refractive power. Further, the following conditional expressions are satisfied:

0.22<Nd3−Nd2 (1); and

2.5<D2/f<4.5 (3), where

Nd3 is a refractive index of the material of the third lens for d-line,

Nd2 is a refractive index of the material of the second lens for d-line,

D2 is an air space between the first lens and the second lens, and

f is a focal length of an entire system.

A third imaging lens of the present disclosure consists of, in order from the object side, a first lens having negative refractive power, a second lens having negative refractive power, a third lens having positive refractive power, and a fourth lens having positive refractive power. Further, the following conditional expressions are satisfied:

0.22<Nd3−Nd2 (1); and

−3.3<R3/f<−1.4 (4), where

Nd3 is a refractive index of the material of the third lens for d-line,

Nd2 is a refractive index of the material of the second lens for d-line,

R3 is a paraxial curvature radius of an object-side surface of the second lens, and

f is a focal length of an entire system.

Here, the first imaging lens of the present disclosure may include the configuration of at least one of the second imaging lens and the third imaging lens of the present disclosure. The second imaging lens of the present disclosure may include the configuration of at least one of the first imaging lens and the third imaging lens of the present disclosure. The third imaging lens of the present disclosure may include the configuration of at least one of the first imaging lens and the second imaging lens of the present disclosure.

The imaging lens of the present disclosure consists of four lenses. However, the imaging lens may include a lens having substantially no refractive power, an optical element, such as a cover glass, other than lenses, a mechanism part, such as a lens flange, a lens barrel, an imaging device and a hand-shake blur correction mechanism, and the like in addition to the four lenses.

In the present disclosure, the surface shape of a lens, such as a convex surface, a concave surface, a flat surface, biconcave, meniscus, biconvex, plano-convex and plano-concave, and the sign of the refractive power of a lens, such as positive and negative, are considered in a paraxial region, unless otherwise mentioned, when the lens includes an aspheric surface. Further, in the present disclosure, the sign of a curvature radius is positive when a surface shape is convex toward the object side, and negative when a surface shape is convex toward the image side. The expression “has positive refractive power at a center of a lens surface” means that the paraxial curvature of the lens surface is a value making the lens surface form a convex surface. Further, the expression “has negative refractive power at a center of a lens surface” means that the paraxial curvature of the lens surface is a value making the lens surface form a concave surface.

In the first through third imaging lenses of the present disclosure, the third lens may have a plano-convex shape with its convex surface facing the object side or a positive meniscus shape with its convex surface facing the object side.

In the first through third imaging lenses of the present disclosure, the fourth lens may have a plano-convex shape with its convex surface facing the image side or a positive meniscus shape with its convex surface facing the image side.

In the first through third imaging lenses of the present disclosure, it is desirable that the following conditional expressions (5) through (17) are satisfied. A desirable mode may include the configuration of one of conditional expressions (5) through (17), or arbitrary two or more of them in combination:

30.0<vd2−vd3 (5);

30.0<vd4−vd3 (6);

−1.0<(R3+R4)/(R3−R4)<1.0 (7);

−10.0<(R5+R6)/(R5−R6)<0.0 (8);

0.0<|f12/f34|<1.0 (9);

2.0<(D4+D5)/f<6.0 (10);

0.5<R5/f<15.0 (11);

0.8<D1/f<3.0 (12);

10.0<L/f<20.0 (13);

0.0<(R8+R9)/(R8−R9)<3.0 (14);

1.5<f3/f<10.0 (15);

8.0<R1/f<30.0 (16); and

1.0<Bf/f<5.0 (17), where

vd2 is an Abbe number of the material of the second lens for d-line,

vd3 is an Abbe number of the material of the third lens for d-line,

vd4 is an Abbe number of the material of the fourth lens for d-line,

R1 is a paraxial curvature radius of an object-side surface of the first lens,

R3 is a paraxial curvature radius of an object-side surface of the second lens,

R4 is a paraxial curvature radius of an image-side surface of the second lens,

R5 is a paraxial curvature radius of an object-side surface of the third lens,

R6 is a paraxial curvature radius of an image-side surface of the third lens,

R8 is a paraxial curvature radius of an object-side surface of the fourth lens,

R9 is a paraxial curvature radius of an image-side surface of the fourth lens,

D1 is a center thickness of the first lens,

D4 is an air space between the second lens and the third lens,

D5 is a center thickness of the third lens,

L is a length from a vertex of an object-side surface of the first lens to an image plane,

f3 is a focal length of the third lens,

f12 is a combined focal length of the first lens and the second lens,

f34 is a combined focal length of the third lens and the fourth lens,

f is a focal length of an entire system, and

Bf is a length from a vertex of an image-side surface of the fourth lens to an image plane.

An imaging apparatus of the present disclosure includes at least one of the first through third imaging lenses of the present disclosure, which is mounted thereon.

According to the first imaging lens of the present disclosure, the arrangement of refractive power in an entire system and the like are appropriately set in a lens system consisting of at least four lenses, and conditional expressions (1) and (2) are satisfied. Therefore, a smaller size, a lower cost and a wider angle of view are achievable. Further, various aberrations are excellently corrected, and an imaging lens having high optical performance in which an excellent image is obtainable even in a peripheral portion of an image formation area is achievable.

According to the second imaging lens of the present disclosure, the arrangement of refractive power in an entire system and the like are appropriately set in a lens system consisting of at least four lenses, and conditional expressions (1) and (3) are satisfied. Therefore, a smaller size, a lower cost and a wider angle of view are achievable. Further, various aberrations are excellently corrected, and an imaging lens having high optical performance in which an excellent image is obtainable even in a peripheral portion of an image formation area is achievable.

According to the third imaging lens of the present disclosure, the arrangement of refractive power in an entire system and the like are appropriately set in a lens system consisting of at least four lenses, and conditional expressions (1) and (4) are satisfied. Therefore, a smaller size, a lower cost and a wider angle of view are achievable. Further, various aberrations are excellently corrected, and an imaging lens having high optical performance in which an excellent image is obtainable even in a peripheral portion of an image formation area is achievable.

The imaging apparatus of the present disclosure includes the imaging lens of the present disclosure. Therefore, the imaging apparatus is configurable in small size and at low cost, and imaging with a wide angle of view is possible, and excellent images with high resolution are obtainable.

### BRIEF DESCRIPTION OF THE DRAWINGS

FIG. 1 is a diagram illustrating the configuration of an imaging lens according to an embodiment of the present disclosure and optical paths;

FIG. 2 is a diagram for explaining the surface shape of a second lens, and the like;

FIG. 3 is a sectional diagram illustrating the lens configuration of an imaging lens in Example 1 of the present disclosure;

FIG. 4 is a sectional diagram illustrating the lens configuration of an imaging lens in Example 2 of the present disclosure;

FIG. 5 is a sectional diagram illustrating the lens configuration of an imaging lens in Example 3 of the present disclosure;

FIG. 6 is a sectional diagram illustrating the lens configuration of an imaging lens in Example 4 of the present disclosure;

FIG. 7 is a sectional diagram illustrating the lens configuration of an imaging lens in Example 5 of the present disclosure;

FIG. 8 is a sectional diagram illustrating the lens configuration of an imaging lens in Example 6 of the present disclosure;

FIG. 9 is a sectional diagram illustrating the lens configuration of an imaging lens in Example 7 of the present disclosure;

FIG. 10 is a sectional diagram illustrating the lens configuration of an imaging lens in Example 8 of the present disclosure;

FIG. 11 is a sectional diagram illustrating the lens configuration of an imaging lens in Example 9 of the present disclosure;

FIG. 12 is a sectional diagram illustrating the lens configuration of an imaging lens in Example 10 of the present disclosure;

FIG. 13, Sections A through D are aberration diagrams of the imaging lens in Example 1 of the present disclosure;

FIG. 14, Sections A through D are aberration diagrams of the imaging lens in Example 2 of the present disclosure;

FIG. 15, Sections A through D are aberration diagrams of the imaging lens in Example 3 of the present disclosure;

FIG. 16, Sections A through D are aberration diagrams of the imaging lens in Example 4 of the present disclosure;

FIG. 17, Sections A through D are aberration diagrams of the imaging lens in Example 5 of the present disclosure;

FIG. 18, Sections A through D are aberration diagrams of the imaging lens in Example 6 of the present disclosure;

FIG. 19, Sections A through D are aberration diagrams of the imaging lens in Example 7 of the present disclosure;

FIG. 20, Sections A through D are aberration diagrams of the imaging lens in Example 8 of the present disclosure;

FIG. 21, Sections A through D are aberration diagrams of the imaging lens in Example 9 of the present disclosure;

FIG. 22, Sections A through D are aberration diagrams of the imaging lens in Example 10 of the present disclosure; and

FIG. 23 is a diagram for explaining arrangement of an imaging apparatus for in-vehicle use according to an embodiment of the present disclosure.

### DESCRIPTION OF THE PREFERRED EMBODIMENTS

Hereinafter, embodiments of the present disclosure will be described in detail with reference to drawings.

[Embodiments of Imaging Lens]

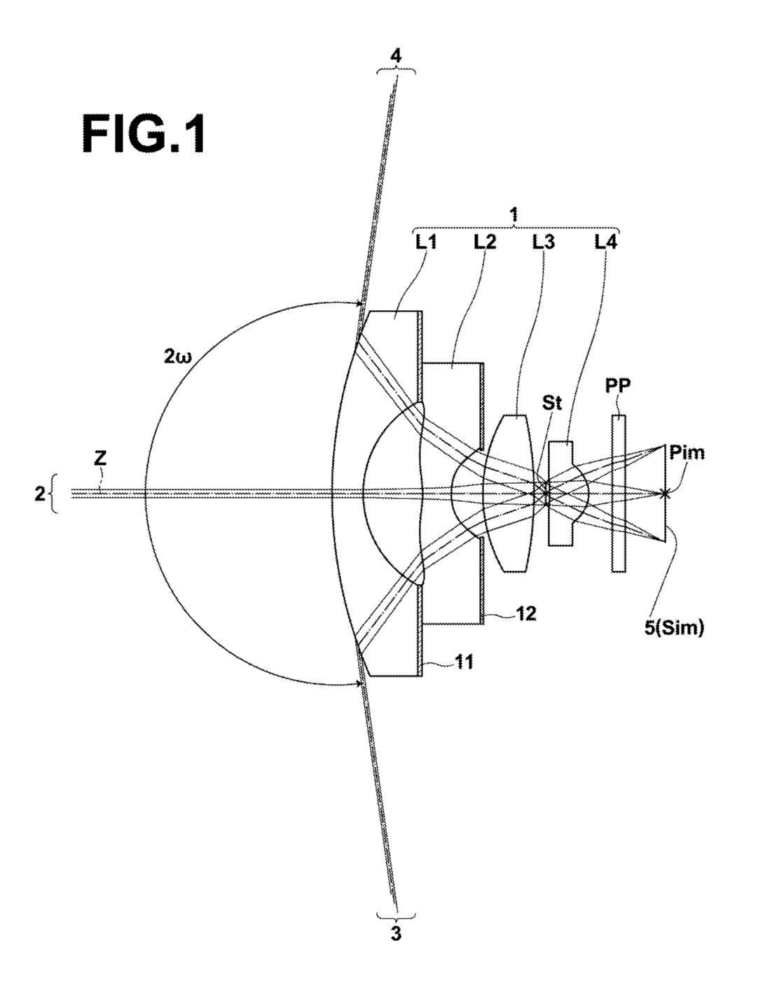

First, an imaging lens according to an embodiment of the present disclosure will be described with reference to FIG. 1. FIG. 1 is a diagram illustrating the configuration of an imaging lens 1 according to an embodiment of the present disclosure and optical paths. The imaging lens 1 illustrated in FIG. 1 corresponds to an imaging lens in Example 1 of the present disclosure, which will be described later.

In FIG. 1, the left side of the diagram is the object side, and the right side of the diagram is the image side. Axial rays 2 from an object point at a distance of infinity and off-axial rays 3, 4 at full angle of view 2w are also illustrated. FIG. 1 illustrates also an imaging device 5 arranged at image plane Sim including image point Pim of the imaging lens 1, considering a case of applying the imaging lens 1 to an imaging apparatus. The imaging device 5 converts an optical image formed by the imaging lens 1 into electrical signals. For example, a CCD image sensor, a CMOS image sensor or the like may be used as the imaging device 5.

When the imaging lens 1 is applied to an imaging apparatus, it is desirable to set a cover glass, a low-pass filter or an infrared ray cut filter and the like, based on the configuration of a camera on which the lens is mounted. FIG. 1 illustrates an example in which parallel-flat-plate-shaped optical member PP, which is assumed to be such elements, is arranged between a lens closest to the image side and the imaging device 5 (image plane Sim).

First, the configuration of the first embodiment of the present disclosure will be described. An imaging lens according to the first embodiment of the present disclosure includes, in order from the object side, first lens L1 having negative refractive power, second lens L2 having negative refractive power, third lens L3 having positive refractive power and fourth lens L4 having positive refractive power. In the example illustrated in FIG. 1, aperture stop St is arranged between third lens L3 and fourth lens L4. In FIG. 1, aperture stop St does not represent the shape nor the size of the aperture stop, but the position of the aperture stop on optical axis Z.

Further, the imaging lens in the first embodiment is configured to satisfy the following conditional expressions (1) and (2):

0.22<Nd3−Nd2 (1); and

1.2<D3/f (2), where

Nd3 is a refractive index of the material of third lens L3 for d-line,

Nd2 is a refractive index of the material of second lens L2 for d-line,

D3 is a center thickness of second lens L2, and

f is a focal length of an entire system.

The imaging lens in the first embodiment consists of four lenses, which are a small number of lenses. Therefore, it is possible to lower the cost and to reduce the total length of the imaging lens in the direction of the optical axis. Further, two negative lenses of negative first lens L1 and negative second lens L2 are arranged closest to the object side. Therefore, the angle of view of the entire lens system is easily widened. Further, since negative refractive power is divided to two lenses, distortion is also easily corrected.

When the lower limit of conditional expression (1) is satisfied, it is possible to increase the refractive index of third lens L3 for d-line, and refractive power of third lens L3 is easily increased, and a lateral chromatic aberration is easily corrected.

When the lower limit of conditional expression (2) is satisfied, the center thickness of second lens L2 is easily increased, and a thickness ratio of second lens L2 is easily suppressed. Therefore, molding of the lens is easy. Further, since a distance between the object-side surface of second lens L2 and the image-side surface of L2 is increased, axial rays and peripheral rays are easily separated from each other at the object-side surface of second lens L2, and curvature of field and distortion are easily corrected.

Next, the configuration of the second embodiment of the present disclosure will be described. An imaging lens according to the second embodiment of the present disclosure includes, in order from the object side, first lens L1 having negative refractive power, second lens L2 having negative refractive power, third lens L3 having positive refractive power, and fourth lens L4 having positive refractive power. In the example illustrated in FIG. 1, aperture stop St is arranged between third lens L3 and fourth lens L4.

Further, the imaging lens in the second embodiment is configured to satisfy the following conditional expressions (1) and (3):

0.22<Nd3−Nd2 (1); and

2.5<D2/f<4.5 (3), where

Nd3 is a refractive index of the material of third lens L3 for d-line,

Nd2 is a refractive index of the material of second lens L2 for d-line,

D2 is an air space between first lens L1 and second lens L2, and

f is a focal length of an entire system.

The imaging lens in the second embodiment consists of four lenses, which are a small number of lenses. Therefore, it is possible to lower the cost and to reduce the total length of the imaging lens in the direction of the optical axis. Further, two negative lenses of negative first lens L1 and negative second lens L2 are arranged closest to the object side. Therefore, the angle of view of the entire lens system is easily widened. Further, since negative refractive power is divided to two lenses, distortion is also easily corrected.

When the lower limit of conditional expression (1) is satisfied, it is possible to increase the refractive index of third lens L3 for d-line, and refractive power of third lens L3 is easily increased, and a lateral chromatic aberration is easily corrected.

When the upper limit of conditional expression (3) is satisfied, an air space between first lens L1 and second lens L2 is easily suppressed, and the size of the lens system is easily reduced. When the lower limit of conditional expression (3) is satisfied, an air space between first lens L1 and second lens L2 is easily widened, and distortion is easily corrected.

Next, the configuration of the third embodiment of the present disclosure will be described. An imaging lens according to the third embodiment of the present disclosure includes, in order from the object side, first lens L1 having negative refractive power, second lens L2 having negative refractive power, third lens L3 having positive refractive power, and fourth lens L4 having positive refractive power. In the example illustrated in FIG. 1, aperture stop St is arranged between third lens L3 and fourth lens L4.

Further, the imaging lens in the third embodiment is configured to satisfy the following conditional expressions (1) and (4):

0.22<Nd3−Nd2 (1); and

−3.3<R3/f<−1.4 (4), where

Nd3 is a refractive index of the material of third lens L3 for d-line,

Nd2 is a refractive index of the material of second lens L2 for d-line,

R3 is a paraxial curvature radius of an object-side surface of second lens L2, and

f is a focal length of an entire system.

The imaging lens in the third embodiment consists of four lenses, which are a small number of lenses. Therefore, it is possible to lower the cost and to reduce the total length of the imaging lens in the direction of the optical axis. Further, two negative lenses of negative first lens L1 and negative second lens L2 are arranged closest to the object side. Therefore, the angle of view of the entire lens system is easily widened. Further, since negative refractive power is divided to two lenses, distortion is also easily corrected.

When the lower limit of conditional expression (1) is satisfied, it is possible to increase the refractive index of third lens L3 for d-line, and refractive power of third lens L3 is easily increased, and a lateral chromatic aberration is easily corrected.

When the upper limit of conditional expression (4) is satisfied, it is possible to prevent the paraxial curvature radius of the object-side surface of second lens L2 from becoming too small, and curvature of field is easily corrected. When the lower limit of conditional expression (4) is satisfied, it is possible to prevent the paraxial curvature radius of the object-side surface of second lens L2 from becoming too large, and an angle of view is easily widened.

Here, the imaging lens according to the first embodiment may include the configuration of the imaging lens according to the second embodiment or the imaging lens according to the third embodiment or the configuration of the imaging lenses according to the second and third embodiments. Further, the imaging lens according to the second embodiment may include the configuration of the imaging lens according to the first embodiment or the imaging lens according to the third embodiment or the configuration of the imaging lenses according to the first and third embodiments. Further, the imaging lens according to the third embodiment may include the configuration of the imaging lens according to the first embodiment or the imaging lens according to the second embodiment or the configuration of the imaging lenses according to the first and second embodiments.

Next, configurations that the imaging lenses according to the first through third embodiments of the present disclosure desirably include will be raised, and their actions and effects will be described. A desirable mode may include one of the following configurations, or arbitrary two or more of them in combination.

30.0<vd2−vd3 (5);

30.0<vd4−vd3 (6);

−1.0<(R3+R4)/(R3−R4)<1.0 (7);

−10.0<(R5+R6)/(R5−R6)<0.0 (8);

0.0<|f12/f34|<1.0 (9);

2.0<(D4+D5)/f<6.0 (10);

0.5<R5/f<15.0 (11);

0.8<D1/f<3.0 (12);

10.0<L/f<20.0 (13);

0.0<(R8+R9)/(R8−R9)<3.0 (14);

1.5<f3/f<10.0 (15);

8.0<R1/f<30.0 (16); and

1.0<Bf/f<5.0 (17), where

vd2 is an Abbe number of the material of second lens L2 for d-line,

vd3 is an Abbe number of the material of third lens L3 for d-line,

vd4 is an Abbe number of the material of fourth lens L4 for d-line,

R1 is a paraxial curvature radius of an object-side surface of first lens L1,

R3 is a paraxial curvature radius of an object-side surface of second lens L2,

R4 is a paraxial curvature radius of an image-side surface of second lens L2,

R5 is a paraxial curvature radius of an object-side surface of third lens L3,

R6 is a paraxial curvature radius of an image-side surface of third lens L3,

R8 is a paraxial curvature radius of an object-side surface of fourth lens L4,

R9 is a paraxial curvature radius of an image-side surface of fourth lens L4,

D1 is a center thickness of first lens L1,

D4 is an air space between second lens L2 and third lens L3,

D5 is a center thickness of third lens L3,

L is a length from a vertex of an object-side surface of first lens L1 to an image plane,

f3 is a focal length of third lens L3,

f12 is a combined focal length of first lens L1 and second lens L2,

f34 is a combined focal length of third lens L3 and fourth lens L4,

f is a focal length of an entire system, and

Bf is a length from a vertex of an image-side surface of fourth lens L4 to an image plane.

When the lower limit of conditional expression (5) is satisfied, the Abbe number of the material of second lens L2 is easily increased, and a longitudinal chromatic aberration and a lateral chromatic aberration are easily corrected, or the Abbe number of the material of third lens L3 is easily reduced, and a lateral chromatic aberration is easily corrected.

When the lower limit of conditional expression (6) is satisfied, the Abbe number of the material of fourth lens L4 is easily increased, and a longitudinal chromatic aberration and a lateral chromatic aberration are easily corrected, or the Abbe number of the material of third lens L3 is easily reduced, and a lateral chromatic aberration is easily corrected.

When the upper limit and the lower limit of conditional expression (7) are satisfied, it is possible to make second lens L2 a biconcave lens, and curvature of field and distortion are easily corrected. When the upper limit of conditional expression (7) is satisfied, the paraxial curvature radius of the object-side surface of second lens L2 is easily reduced while the object-side surface of second lens L2 is made concave. Therefore, the refractive power of second lens L2 is easily increased, and distortion is easily corrected. When the lower limit of conditional expression (7) is satisfied, the paraxial curvature radius of the image-side surface of second lens L2 is easily reduced, and an angle of view is easily widened.

When the upper limit of conditional expression (8) is satisfied, it is possible to obtain an optical system in which the paraxial curvature radius of the image-side surface of third lens L3 is larger than the paraxial curvature radius of the object-side surface of third lens L3, and curvature of field is easily corrected. When the lower limit of conditional expression (8) is satisfied, the refractive power of third lens L3 is easily increased, and a lateral chromatic aberration is easily corrected.

When the upper limit of conditional expression (9) is satisfied, an angle of view is easily widened and curvature of field is reduced at the same time, and excellent images are easily obtained. The lower limit of conditional expression (9) is 0. However, since conditional expression (9) defines the absolute value of a ratio of combined focal length f12 of first lens L1 and second lens L2 to combined focal length f34 of third lens L3 and fourth lens L4, there is no possibility that the value is less than 0.

When conditional expression (10) is satisfied, it is possible to excellently correct a spherical aberration, distortion and a coma aberration. Further, it is possible to provide a long back focus, and to widen an angle of view, and excellent performance is achievable. When the upper limit of conditional expression (10) is satisfied, the diameter of the concave lens closest to the object side is easily suppressed, and the total lens length is easily suppressed. Therefore, the size of the lens system is easily reduced, and an angle of view is easily secured. When the lower limit of conditional expression (10) is satisfied, a spherical aberration and a coma aberration are easily corrected, and a fast lens is easily obtainable.

When the upper limit of conditional expression (11) is satisfied, the paraxial curvature radius of the object-side surface of third lens L3 is easily reduced, and the refractive power of third lens L3 is easily increased, and a lateral chromatic aberration is easily corrected. When the lower limit of conditional expression (11) is satisfied, the paraxial curvature radius of the object-side surface of third lens L3 is easily increased, and the refractive power of third lens L3 is easily suppressed. Further, sensitivity to an error caused by eccentricity is easily reduced, and production becomes easy.

When the imaging lens according to an embodiment of the present disclosure is used, for example, as a lens for an in-vehicle camera, first lens L1 needs to have strength against various kinds of shock. Therefore, it is desirable that conditional expression (12) is satisfied. When the upper limit of conditional expression (12) is satisfied, the size of the lens system is easily reduced. When the lower limit of conditional expression (12) is satisfied, it is possible to secure the thickness of first lens L1, and to make first lens L1 less breakable.

When the upper limit and the lower limit of conditional expression (13) are satisfied, it is possible to achieve a smaller size and a wider angle of view at the same time. When the upper limit of conditional expression (13) is satisfied, the size of the lens is easily reduced. When the lower limit of conditional expression (13) is satisfied, an angle of view is easily widened.

When the upper limit of conditional expression (14) is satisfied, the refractive power of fourth lens L4 is easily increased, and an incident angle of rays entering an imaging device is easily suppressed, and shading is easily suppressed. When the lower limit of conditional expression (14) is satisfied, it is possible to make the paraxial curvature radius of the image-side surface of fourth lens L4 smaller than the paraxial curvature radius of the object-side surface of fourth lens L4, and to excellently correct curvature of field and a spherical aberration.

When the upper limit of conditional expression (15) is satisfied, the refractive power of third lens L3 is easily increased, and a lateral chromatic aberration is easily corrected. When the lower limit of conditional expression (15) is satisfied, the refractive power of third lens L3 is easily suppressed. Further, sensitivity to an error caused by eccentricity is easily reduced, and production becomes easy.

When the upper limit of conditional expression (16) is satisfied, the paraxial curvature radius of the object-side surface of first lens L1 is easily reduced. Therefore, distortion is easily corrected. When the lower limit of conditional expression (16) is satisfied, the paraxial curvature radius of the object-side surface of first lens L1 is easily increased, and the refractive power of first lens L1 is easily increased. Therefore, the size of the lens system in the direction of the diameter is easily reduced, or the angle of view is easily widened.

When the upper limit of conditional expression (17) is satisfied, the size of the lens system is easily reduced. When the lower limit of conditional expression (17) is satisfied, various filters, a cover glass and the like are easily insertable between the lens system and an imaging device.

Here, regarding each of the aforementioned conditional expressions, it is desirable to further satisfy a conditional expression in which an upper limit is added, or a lower limit is added, or a lower limit or an upper limit is modified, as will be described next, to improve the aforementioned action and effect. Further, a desirable mode may satisfy a conditional expression composed of a combination of a modified lower limit and a modified upper limit that will be described next. Next, desirable modification examples of conditional expressions will be described, as examples. However, the modification examples of conditional expressions are not limited to the following examples, represented by the expressions, but may be a combination of modified values described in the expressions.

It is desirable that the lower limit of conditional expression (1) is 0.25. Then, the refractive power of third lens L3 is more easily increased, and a lateral chromatic aberration is more easily corrected. It is more desirable that the lower limit of conditional expression (1) is 0.3, and 0.35 is even more desirable. It is desirable that an upper limit is set for conditional expression (1). It is desirable that the upper limit is 0.8, and 0.7 is more desirable. Then, the refractive index of third lens L3 is prevented from becoming too high, and the cost of third lens L3 is easily prevented from becoming too high. Therefore, the cost is easily reduced. As described above, it is more desirable, for example, that the following conditional expressions (1-1) through (1-4) are satisfied:

0.22<Nd3−Nd2<0.8 (1-1);

0.25<Nd3−Nd2 (1-2);

0.3<Nd3−Nd2 (1-3); or

0.25<Nd3−Nd2<0.7 (1-4).

It is desirable that the lower limit of conditional expression (2) is 1.22 or higher. Then, axial rays and peripheral rays are more easily separated from each other at the object-side surface of second lens L2, and curvature of field and distortion are more easily corrected. It is desirable that an upper limit is set for conditional expression (2). It is desirable that the upper limit is 3.0, and 2.0 is more desirable, and 1.8 is even more desirable, and 1.5 is still more desirable. Then, the center thickness of second lens L2 is easily suppressed. As described above, it is more desirable, for example, that the following conditional expressions (2-1) through (2-5) are satisfied:

1.2<D3/f<3.0 (2-1);

1.2<D3/f<2.0 (2-2);

1.2<D3/f<1.8 (2-3);

1.2<D3/f<1.5 (2-4); or

1.22<D3/f (2-5).

It is desirable that the upper limit of conditional expression (3) is 4.0. Then, an air space between first lens L1 and second lens L2 is more easily suppressed, and the size of the lens system is more easily reduced. It is more desirable that the upper limit of conditional expression (3) is 3.5, and 3.2 is even more desirable. As described above, it is more desirable, for example, that the following conditional expressions (3-1) through (3-3) are satisfied:

2.5<D2/f<4.0 (3-1);

2.5<D2/f<3.5 (3-2); or

2.5<D2/f<3.2 (3-3).

It is desirable that the upper limit of conditional expression (4) is −1.7. Then, it is possible to more effectively prevent the paraxial curvature radius of the object-side surface of second lens L2 from becoming too small, and curvature of field is more easily corrected. It is more desirable that the upper limit of conditional expression (4) is −1.9, and −2.0 is even more desirable. It is desirable that the lower limit of conditional expression (4) is −3.28. Then, it is possible to more effectively prevent the paraxial curvature radius of the object-side surface of second lens L2 from becoming too large, and an angle of view is more easily widened. It is more desirable that the lower limit of conditional expression (4) is −3.0. As described above, it is more desirable, for example, that the following conditional expressions (4-1) through (4-3) are satisfied:

−3.3<R3/f<−1.7 (4-1);

−3.3<R3/f<−1.9 (4-2); or

−3.28<R3/f<−2.0 (4-3).

It is desirable that the lower limit of conditional expression (5) is 32. Then, the Abbe number of the material of second lens L2 is more easily increased, and a longitudinal chromatic aberration and a lateral chromatic aberration are more easily corrected, or the Abbe number of the material of third lens L3 is more easily reduced, and a lateral chromatic aberration is more easily corrected. It is more desirable that the lower limit of conditional expression (5) is 35, and 36 is even more desirable. It is desirable to set an upper limit for conditional expression (5). It is desirable that the upper limit is 50, and 45 is more desirable. Then, the cost of the material of second lens L2 and third lens L3 is easily suppressed, and the price of the lens system is easily lowered. As described above, it is more desirable, for example, that the following conditional expressions (5-1) through (5-4) are satisfied:

32.0<vd2−vd3 (5-1);

35.0<vd2−vd3 (5-2);

35.0<vd2−vd3<50.0 (5-3); or

36.0<vd2−vd3<45.0 (5-4).

It is desirable that the lower limit of conditional expression (6) is 32. Then, the Abbe number of the material of fourth lens L4 is more easily increased, and a longitudinal chromatic aberration and a lateral chromatic aberration are more easily corrected, or the Abbe number of the material of third lens L3 is more easily reduced, and a lateral chromatic aberration is more easily corrected. It is more desirable that the lower limit of conditional expression (6) is 35, and 36 is even more desirable. It is desirable to set an upper limit for conditional expression (6). It is desirable that the upper limit is 50, and 45 is more desirable. Then, the cost of the material of third lens L3 and fourth lens L4 is easily suppressed, and the price of the lens system is easily lowered. As described above, it is more desirable, for example, that the following conditional expressions (6-1) through (6-4) are satisfied:

32.0<vd4−vd3 (6-1);

35.0<vd4−vd3 (6-2);

35.0<vd4−vd3<50.0 (6-3); or

36.0<vd4−vd3<45.0 (6-4).

It is desirable that the upper limit of conditional expression (7) is 0.8. Then, the paraxial curvature radius of the object-side surface of second lens L2 is more easily reduced, and the refractive power of second lens L2 is more easily increased, and distortion is more easily corrected. It is more desirable that the upper limit of conditional expression (7) is 0.5, and 0.4 is even more desirable. It is desirable that the lower limit of conditional expression (7) is −0.8. Then, the paraxial curvature radius of the image-side surface of second lens L2 is more easily reduced, and an angle of view is more easily widened. It is more desirable that the lower limit of conditional expression (7) is −0.5, and −0.4 is even more desirable, and −0.3 is still more desirable. As described above, it is more desirable, for example, that the following conditional expressions (7-1) through (7-5) are satisfied:

−0.8<(R3+R4)/(R3−R4)<0.8 (7-1);

−0.5<(R3+R4)/(R3−R4)<0.5 (7-2);

−0.4<(R3+R4)/(R3−R4)<0.4 (7-3);

−0.3<(R3+R4)/(R3−R4)<0.8 (7-4); or

−0.4<(R3+R4)/(R3−R4)<1.0 (7-5).

It is desirable that the upper limit of conditional expression (8) is −0.2. Then, it is possible to obtain an optical system in which the paraxial curvature radius of the image-side surface of third lens L3 is larger than the paraxial curvature radius of the object-side surface of third lens L3, and curvature of field is more easily corrected. It is more desirable that the upper limit of conditional expression (8) is −0.3. It is desirable that the lower limit of conditional expression (8) is −5. Then, the refractive power of third lens L3 is more easily increased, and a lateral chromatic aberration is more easily corrected. It is more desirable that the lower limit of conditional expression (8) is −4.0, and −3.0 is even more desirable. As described above, it is more desirable, for example, that the following conditional expressions (8-1) through (8-5) are satisfied:

−5.0<(R5+R6)/(R5−R6)<0.0 (8-1);

−5.0<(R5+R6)/(R5−R6)<−0.2 (8-2);

−5.0<(R5+R6)/(R5−R6)<−0.3 (8-3);

−4.0<(R5+R6)/(R5−R6)<−0.3 (8-4); or

−10.0<(R5+R6)/(R5−R6)<−0.2 (8-5).

It is desirable that the upper limit of conditional expression (9) is 0.7. Then, an angle of view is more easily widened and curvature of field is reduced more at the same time, and more excellent images are obtainable. It is more desirable that the upper limit of conditional expression (9) is 0.5, and 0.4 is even more desirable, and 0.3 is still more desirable. It is desirable that the lower limit of conditional expression (9) is 0.01. Then, a coma aberration is more easily corrected, and an excellent image is more easily obtained in a peripheral area. It is more desirable that the lower limit of conditional expression (9) is 0.05. As described above, it is more desirable, for example, that the following conditional expressions (9-1) through (9-4) are satisfied:

0.0<|f12/f34|<0.7 (9-1);

0.0<|f12/f34|<0.5 (9-2);

0.0<|f12/f34|<0.4 (9-3); or

0.0<|f12/f34≦0.3 (9-4).

It is desirable that the upper limit of conditional expression (10) is 5.5. Then, it is possible to more excellently correct a spherical aberration, distortion and a coma aberration. Further, it is possible to provide a longer back focus, and to widen an angle of view, and excellent performance is achievable. It is more desirable that the upper limit of conditional expression (10) is 4.5. It is desirable that the lower limit of conditional expression (10) is 2.5. Then, a spherical aberration and a coma aberration are more easily corrected, and a fast lens is more easily obtainable. It is more desirable that the lower limit of conditional expression (10) is 2.7. As described above, it is more desirable, for example, that the following conditional expressions (10-1) and (10-2) are satisfied:

2.5<(D4+D5)/f<5.5 (10-1); or

2.7<(D4+D5)/f<4.5 (10-2).

It is desirable that the upper limit of conditional expression (11) is 12.0. Then, the paraxial curvature radius of the object-side surface of third lens L3 is more easily reduced, and the refractive power of third lens L3 is more easily increased, and a lateral chromatic aberration is more easily corrected. It is more desirable that the upper limit of conditional expression (11) is 10.0, and 9.0 is even more desirable, and 8.0 is still more desirable. It is desirable that the lower limit of conditional expression (11) is 1.0. Then, the paraxial curvature radius of the object-side surface of third lens L3 is more easily increased, and sensitivity to an error caused by eccentricity is more easily reduced, and production becomes easier. It is more desirable that the lower limit of conditional expression (11) is 1.5, and 2.0 is even more desirable. As described above, it is more desirable, for example, that the following conditional expressions (11-1) through (11-5) are satisfied:

0.5<R5/f<12.0 (11-1);

1.0<R5/f<10.0 (11-2);

1.0<R5/f<9.0 (11-3);

1.5<R5/f<9.0 (11-4); or

2.0<R5/f<8.0 (11-5).

It is desirable that the upper limit of conditional expression (12) is 2.0. Then, it is possible to reduce the size of the lens system. It is more desirable that the upper limit of conditional expression (12) is 1.5. It is desirable that the lower limit of conditional expression (12) is 0.9. Then, it is possible to prevent breakage of first lens L1. It is more desirable that the lower limit of conditional expression (12) is 1.0. As described above, it is more desirable, for example, that the following conditional expressions (12-1) through (12-3) are satisfied:

0.9<D1/f<2.0 (12-1);

1.0<D1/f<2.0 (12-2); or

1.0<D1/f<1.5 (12-3).

It is desirable that the upper limit of conditional expression (13) is 18.0. Then, it is possible to reduce the size of the lens system. It is more desirable that the upper limit of conditional expression is 15.0. It is desirable that the lower limit of conditional expression (13) is 11.0. Then, it is possible to achieve a smaller size and a wider angle of the lens system. As described above, it is more desirable, for example, that the following conditional expressions (13-1) through (13-3) are satisfied:

10.0<L/f<18.0 (13-1);

10.0<L/f<15.0 (13-2); or

11.0<L/f<15.0 (13-3).

Here, it is desirable that length L from the object-side surface of first lens L1 to a light receiving element is 15 mm or less to reduce the size of the lens system, and 13 mm or less is more desirable.

It is desirable that the upper limit of conditional expression (14) is 2.0. Then, the refractive power of fourth lens L4 is more easily increased, and an incident angle of rays entering an imaging device is more easily suppressed, and shading is more easily suppressed. It is more desirable that the upper limit of conditional expression (14) is 1.7, and 1.6 is even more desirable. It is desirable that the lower limit of conditional expression (14) is 0.2. Then, it is possible to easily increase the paraxial curvature radius of the object-side surface of fourth lens L4, and to more excellently correct curvature of field and a spherical aberration. It is more desirable that the lower limit of conditional expression (14) is 0.3, and 0.4 is even more desirable. As described above, it is more desirable, for example, that the following conditional expressions (14-1) through (14-5) are satisfied:

0.0<(R8+R9)/(R8−R9)<2.0 (14-1);

0.2<(R8+R9)/(R8−R9)<2.0 (14-2);

0.3<(R8+R9)/(R8−R9)<1.7 (14-3);

0.4<(R8+R9)/(R8−R9)<1.6 (14-4); or

0.46<(R8+R9)/(R8−R9)<3.0 (14-5).

It is desirable that the upper limit of conditional expression (15) is 9.0. Then, the refractive power of third lens L3 is more easily increased, and a lateral chromatic aberration is more easily corrected. It is more desirable that the upper limit of conditional expression (15) is 8.0. It is desirable that the lower limit of conditional expression (15) is 2.0. Then, the refractive power of third lens L3 is more easily suppressed. Further, sensitivity to an error caused by eccentricity is more easily reduced, and production becomes easier. It is more desirable that the lower limit of conditional expression (15) is 3.0. As described above, it is more desirable, for example, that the following conditional expressions (15-1) through (15-3) are satisfied:

1.5<f3/f<9.0 (15-1);

2.0<f3/f<9.0 (15-2); or

3.0<f3/f<8.0 (15-3).

It is desirable that the upper limit of conditional expression (16) is 28.0. Then, the paraxial curvature radius of the object-side surface of first lens L1 is more easily reduced. Therefore, distortion is more easily corrected. It is more desirable that the upper limit of conditional expression (16) is 25.0, and 22.0 is even more desirable. It is desirable that the lower limit of conditional expression (16) is 10.0. Then, the paraxial curvature radius of the object-side surface of first lens L1 is more easily increased, and the refractive power of first lens L1 is more easily increased. Therefore, the size of the lens system in the direction of the diameter is more easily reduced, or the angle of view is more easily widened. It is more desirable that the lower limit of conditional expression (16) is 11.0, and 12.0 is even more desirable. As described above, it is more desirable, for example, that the following conditional expressions (16-1) through (16-4) are satisfied:

8.0<R1/f<28.0 (16-1);

10.0<R1/f<25.0 (16-2);

11.0<R1/f<22.0 (16-3); or

12.0<R1/f<22.0 (16-4).

It is desirable that the upper limit of conditional expression (17) is 4.0. Then, the size of the lens system is more easily reduced. It is desirable that the lower limit of conditional expression (17) is 2.0. Then, various filters, a cover glass and the like are more easily insertable between the lens system and an imaging device. It is more desirable that the lower limit of conditional expression (17) is 2.5. As described above, it is more desirable, for example, that the following conditional expressions (17-1) and (17-2) are satisfied:

2.0<Bf/f<4.0 (17-1); or

2.5<Bf/f<4.0 (17-2).

It is desirable that Abbe number vd1 of the material of first lens L1 for d-line is 40 or higher. Then, it is possible to suppress generation of chromatic aberrations, and to achieve excellent resolution performance, and 45 or higher is more desirable.

It is desirable that Abbe number vd2 of the material of second lens L2 for d-line is 40 or higher. Then, it is possible to suppress generation of chromatic aberrations, and to achieve excellent resolution performance, and 45 or higher is more desirable, and 50 or higher is even more desirable.

It is desirable that Abbe number vd3 of the material of third lens L3 for d-line is 40 or less. Then, it is possible to excellently correct a lateral chromatic aberration, and 30 or less is more desirable, and 28 or less is even more desirable, and 25 or less is still more desirable. Further, 20 or less is more desirable, and 19 or less is even more desirable.

It is desirable that Abbe number vd4 of the material of fourth lens L4 for d-line is 40 or higher. Then, it is possible to suppress generation of chromatic aberrations, and to achieve excellent resolution performance, and 45 or higher is more desirable, and 50 or higher is even more desirable.

It is desirable that all of Abbe numbers vd1, vd2 and vd4 of the material of first lens L1, second lens L2 and fourth lens L4 for d-line are 40 or higher. Then, it is possible to suppress generation of chromatic aberrations, and to achieve excellent resolution performance.

An aperture stop is a stop determining the F-number (Fno) of a lens system. It is desirable that aperture stop St is arranged between the object-side surface of third lens L3 and the image-side surface of fourth lens L4. Then, the size of the entire system is easily reduced. It is more desirable that aperture stop St is arranged between the image-side surface of third lens L3 and the object-side surface of fourth lens L4. Then, the size of the entire system is easily reduced.

It is desirable that at least one of the surfaces of first lens L1 through fourth lens L4 is an aspheric surface. Then, it is possible to excellently correct various aberrations.

It is desirable that at least one of the surfaces of second lens L2 is an aspheric surface. When at least one of the surfaces of second lens L2 is an aspheric surface, curvature of field and a spherical aberration are easily corrected, and excellent resolution performance is achievable. It is more desirable that both of the surfaces of second lens L2 are aspheric surfaces.

It is desirable that the object-side surface of second lens L2 is an aspheric surface. It is desirable that the object-side surface of second lens L2 is shaped in such a manner that a center has negative refractive power and an effective diameter edge has positive refractive power. When second lens L2 has such a shape, curvature of field and distortion are excellently corrected while an angle of view is widened at the same time.

The phrase “effective diameter of a surface” means the diameter of a circle composed of outermost points (points farthest from an optical axis) in the direction of the diameter when points at which all rays contributing to image formation and a lens surface intersect with each other are considered. The term “effective diameter edge” means these outermost points. Here, when a system is rotationally symmetrical with respect to an optical axis, a figure composed of the outermost points is a circle. However, when the system is not rotationally symmetrical, the figure is not a circle in some cases. In such a case, an equivalent circle may be considered, and the diameter of the circle may be used as the effective diameter.

Regarding the shape of an aspheric surface, when a point on lens surface i of each lens is Xi (the sign of i represents a corresponding lens surface. For example, when the object-side surface of second lens L2 is represented by 3, the sign of i may be regarded as i=3 in the following explanation about the object-side surface of second lens L2), and an intersection of a normal at the point and an optical axis is Pi, the length of Xi−Pi (|Xi−Pi|) is defined as the absolute value |RXi| of a curvature radius at point Xi, and Pi is defined as the center of a curvature at point Xi. Further, an intersection of the i-th lens surface and the optical axis is Qi. At this time, refractive power at point Xi is defined based on whether point Pi is located toward the object side of point Qi or toward the image side of point Qi. Regarding the object-side surface, the refractive power is defined as positive refractive power when point Pi is located toward the image side of point Qi, and the refractive power is defined as negative refractive power when point Pi is located toward the object side of point Qi. Regarding the image-side surface, the refractive power is defined as positive refractive power when point Pi is located toward the object side of point Qi, and the refractive power is defined as negative refractive power when point Pi is located toward the image side of point Qi.

When refractive power at a center and refractive power at point Xi are compared with each other, the absolute value of a curvature radius at the center (a paraxial curvature radius) and the absolute value |RXi| of a curvature radius at point Xi are compared with each other. When |RXi| is smaller than the absolute value of the paraxial curvature radius, the refractive power at point Xi is judged to be stronger, compared with the refractive power at the center. In contrast, when |RXi| is greater than the absolute value of the paraxial curvature radius, the refractive power at point Xi is judged to be weaker, compared with the refractive power at the center. This is the same for both of a case in which a surface has positive refractive power and a case in which a surface has negative refractive power.

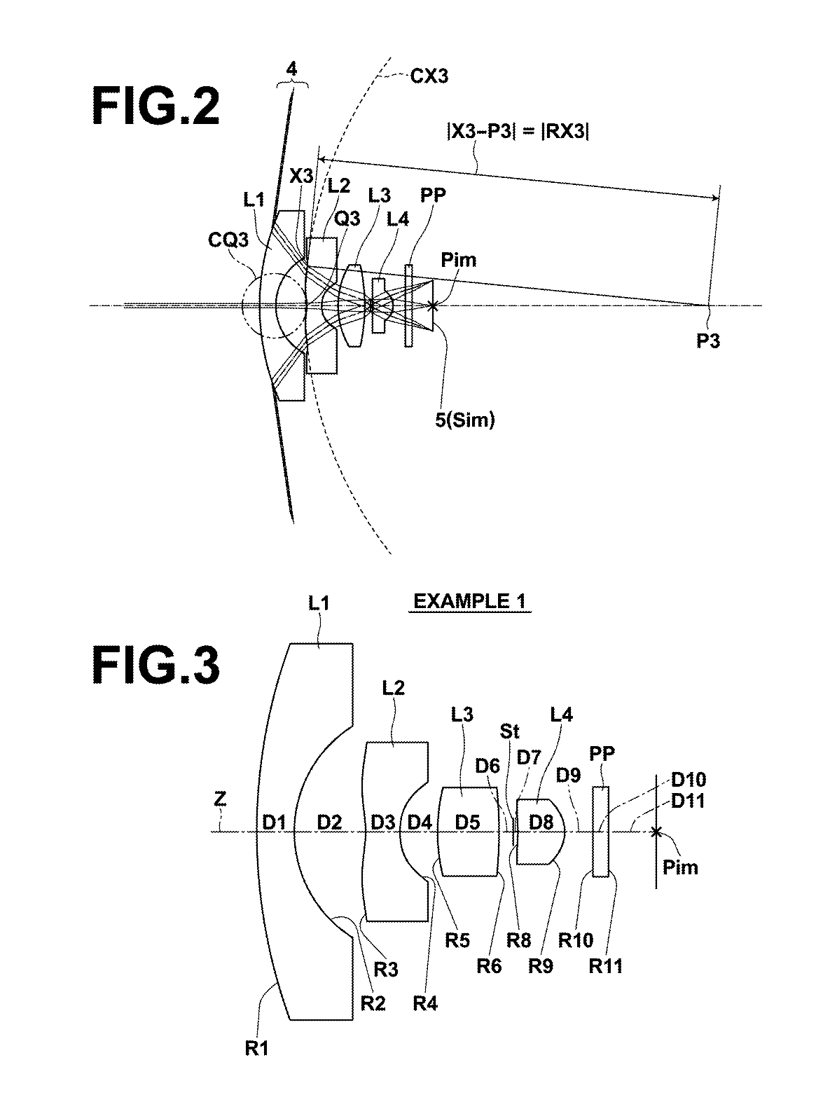

Here, with reference to FIG. 2, the shape of the object-side surface of second lens L2 will be described. FIG. 2 is an optical path diagram of the imaging lens 1 illustrated in FIG. 1. In FIG. 2, point Q3 is a center of the object-side surface of second lens L2, which is an intersection of the object-side surface of second lens L2 and optical axis Z. In FIG. 2, point X3 on the object-side surface of second lens L2 is located at an effective diameter edge, and point X3 is an intersection of an outermost ray included in off-axial rays 4 and the object-side surface of second lens L2. In FIG. 2, point X3 is located at the effective diameter edge. However, since point X3 is an arbitrary point on the object-side surface of second lens L2, even if point X3 is a different point, point X3 may be considered in the same manner.

At this time, an intersection of a normal to the lens surface at point X3 and optical axis Z is P3, as illustrated in FIG. 2, and the segment X3−P3, which connects point X3 and point P3 to each other, is defined as curvature radius RX3 at point X3, and the length |X3−P3| of the segment X3−P3 is defined as the absolute value |RX3| of curvature radius RX3. In other words, |X3−P3|=|RX3|. Further, a curvature radius at point Q3, in other words, a curvature radius at the center of the object-side surface of second lens L2 is R3, and the absolute value of the curvature radius is |R3|(not illustrated in FIG. 2).

The expression that the object-side surface of second lens L2 is “shaped in such a manner that a center has negative refractive power and an effective diameter edge has positive refractive power” means a shape in which when point X3 is located at an effective diameter edge, a paraxial region including point Q3 is concave, and point P3 is located toward the image side of point Q3.

For the purpose of facilitating understanding, in FIG. 2, circle CQ3, which passes through point Q3 at the radius of |R3| with its center located on the optical axis, is drawn with a two-dot dashed line. Further, a part of circle CX3, which passes through point X3 at the radius of |RX3| with its center located on the optical axis, is drawn by a broken line. In FIG. 2, Circle CX3 is larger than circle CQ3, and |R3|<|RX3| is clearly illustrated.

The object-side surface of second lens L2 may have negative refractive power both at a center and at an effective diameter edge, and be shaped in such a manner that the negative refractive power at the effective diameter edge is weaker, compared with the negative refractive power at the center. When second lens L2 has such a shape, curvature of field and distortion are excellently corrected while an angle of view is widened at the same time.

The expression that the object-side surface of second lens L2 “has negative refractive power both at a center and at an effective diameter edge, and is shaped in such a manner that the negative refractive power at the effective diameter edge is weaker, compared with the negative refractive power at the center” means a shape in which when point X3 is located at an effective diameter edge, a paraxial region including point Q3 is concave, and point P3 is located toward the object side of point Q3, and the absolute value |RX3| of the curvature radius at point X3 is greater than the absolute value |R3| of the curvature radius at point Q3.

It is desirable that an image-side surface of second lens L2 is an aspheric surface. It is desirable that the image-side surface of second lens L2 has negative refractive power both at a center and at an effective diameter edge, and is shaped in such a manner that the negative refractive power at the effective diameter edge is stronger, compared with the negative refractive power at the center. When the image-side surface of second lens L2 has such a shape, curvature of field is easily corrected.

The shape of the image-side surface of second lens L2 may be considered in the following manner similar to the shape of the object-side surface of second lens L2, explained using FIG. 2. In a sectional diagram of the lens, when a point on the image-side surface of second lens L2 is X4, and an intersection of a normal at the point and optical axis Z is P4, the segment X4−P4, which connects point X4 and point P4 to each other, is defined as a curvature radius at point X4, and the length |X4-P4| of the segment connecting point X4 and point P4 to each other is defined as the absolute value |RX4| of the curvature radius at point X4. Therefore, |X4−P4|=|RX4|. Further, an intersection of the image-side surface of second lens L2 and optical axis Z, in other words, a center of the image-side surface of second lens L2 is point Q4, and the absolute value of a curvature radius at point Q4 is |R4|.

The expression that the image-side surface of second lens L2 “has negative refractive power both at a center and at an effective diameter edge, and is shaped in such a manner that the negative refractive power at the effective diameter edge is stronger, compared with the negative refractive power at the center” means a shape in which when point X4 is located at an effective diameter edge, a paraxial region including point Q4 is concave, and point P4 is located toward the image side of point Q4, and the absolute value |RX4| of the curvature radius at point X4 is smaller than the absolute value |R4| of the curvature radius at point Q4.

It is desirable that at least one of the surfaces of fourth lens L4 is an aspheric surface. When at least one of the surfaces of fourth lens L4 is an aspheric surface, curvature of field and a spherical aberration are easily corrected, and excellent resolution performance is achievable. It is more desirable that both of the surfaces of fourth lens L4 are aspheric surfaces.

It is desirable that the object-side surface of fourth lens L4 is an aspheric surface. It is desirable that the object-side surface of fourth lens L4 has negative refractive power both at a center and at an effective diameter edge, and is shaped in such a manner that the negative refractive power at the effective diameter edge is stronger, compared with the negative refractive power at the center. When fourth lens L4 has such a shape, it is possible to excellently correct curvature of field.

The shape of the object-side surface of fourth lens L4 may be considered in the following manner similar to the shape of the object-side surface of second lens L2, explained using FIG. 2. In a sectional diagram of the lens, when a point on the object-side surface of fourth lens L4 is X8, and an intersection of a normal at the point and optical axis Z is P8, the segment X8−P8, which connects point X8 and point P8 to each other, is defined as a curvature radius at point X8, and the length |X8−P8| of the segment connecting point X8 and point P8 to each other is defined as the absolute value |RX8| of the curvature radius at point X8. Therefore, |X8−P8|=|RX8|. Further, an intersection of the object-side surface of fourth lens L4 and optical axis Z, in other words, a center of the object-side surface of fourth lens L4 is point Q8, and the absolute value of a curvature radius at point Q8 is |R8|.

The expression that the object-side surface of fourth lens L4 “has negative refractive power both at a center and at an effective diameter edge, and is shaped in such a manner that the negative refractive power at the effective diameter edge is stronger, compared with the negative refractive power at the center” means a shape in which when point X8 is located at an effective diameter edge, a paraxial region including point Q8 is concave, and point P8 is located toward the object side of point Q8, and the absolute value |RX8| of the curvature radius at point X8 is smaller than the absolute value |R8| of the curvature radius at point Q8.

The object-side surface of fourth lens L4 may have positive refractive power both at a center and at an effective diameter edge, and be shaped in such a manner that the positive refractive power at the effective diameter edge is weaker, compared with the positive refractive power at the center. When fourth lens L4 has such a shape, it is possible to excellently correct curvature of field.

The expression that the object-side surface of fourth lens L4 “has positive refractive power both at a center and at an effective diameter edge, and is shaped in such a manner that the positive refractive power at the effective diameter edge is weaker, compared with the positive refractive power at the center” means a shape in which when point X8 is located at an effective diameter edge, a paraxial region including point Q8 is convex, and point P8 is located toward the image side of point Q8, and the absolute value |RX8| of the curvature radius at point X8 is greater than the absolute value |R8| of the curvature radius at point Q8.

It is desirable that the image-side surface of fourth lens L4 is an aspheric surface. It is desirable that the image-side surface of fourth lens L4 has positive refractive power both at a center and at an effective diameter edge, and is shaped in such a manner that the positive refractive power at the effective diameter edge is weaker, compared with the positive refractive power at the center. When fourth lens L4 has such a shape, it is possible to excellently correct a spherical aberration, curvature of field and a coma aberration.

The shape of the image-side surface of fourth lens L4 may be considered in the following manner similar to the shape of the object-side surface of second lens L2, explained using FIG. 2. In a sectional diagram of the lens, when a point on the image-side surface of fourth lens L4 is X9, and an intersection of a normal at the point and optical axis Z is P9, the segment X9−P9, which connects point X9 and point P9 to each other, is defined as a curvature radius at point X9, and the length |X9−P9| of the segment connecting point X9 and point P9 to each other is defined as the absolute value |RX9| of the curvature radius at point X9. Therefore, |X9−P9|=|RX9|. Further, an intersection of the image-side surface of fourth lens L4 and optical axis Z, in other words, a center of the image-side surface of fourth lens L4 is point Q9, and the absolute value of a curvature radius at point Q9 is |R9|.

The expression that the image-side surface of fourth lens L4 “has positive refractive power both at a center and at an effective diameter edge, and is shaped in such a manner that the positive refractive power at the effective diameter edge is weaker, compared with the positive refractive power at the center” means a shape in which when point X9 is located at an effective diameter edge, a paraxial region including point Q9 is convex, and point P9 is located toward the object side of point Q9, and the absolute value |RX9| of the curvature radius at point X9 is greater than the absolute value |R9| of the curvature radius at point Q9.

It is desirable that first lens L1 is a meniscus lens with its convex surface facing the object side. Then, it is possible to produce a wide angle lens exceeding 180 degrees.

It is desirable that second lens L2 is a biconcave lens. Then, it is possible to easily widen an angle of view, and to excellently correct distortion and curvature of field.

It is desirable that third lens L3 is a biconvex lens. Then, curvature of field and a lateral chromatic aberration are easily corrected.

Third lens L3 may have a plano-convex shape with its convex surface facing the object side, or a positive meniscus shape with its convex surface facing the object side. Then, curvature of field is easily corrected.

It is desirable that fourth lens L4 has a plano-convex shape with its convex surface facing the image side, or a positive meniscus shape with its convex surface facing the image side. Then, a spherical aberration and curvature of field are excellently corrected.

Fourth lens L4 may be a biconvex lens. Then, it is possible to excellently correct a spherical aberration and curvature of field, and to easily suppress an incident angle of peripheral rays entering an imaging device.

It is desirable that the material of first lens L1 is glass. When an imaging lens is used in tough environment conditions, for example, such as use in an in-vehicle camera or a surveillance camera, first lens L1, which is arranged closest to the object side, needs to use a material resistant to a deterioration of surface by wind and rain and a change in temperature by direct sun light, and also resistant to chemicals, such as oils and fats and detergents. In other words, the material needs to be highly water-resistant, weather-resistant, acid-resistant, chemical-resistant, and the like. Further, in some cases, the material needs to be hard and not easily breakable. If the material is glass, it is possible to satisfy such needs. Alternatively, transparent ceramic may be used as the material of first lens L1.

The material of first lens L1 may be glass, and at least one of the surfaces of first lens L1 may be an aspheric surface. When first lens L1 is an aspheric lens of glass, it is possible to correct various aberrations more excellently.

Further, a protection means for increasing the strength, scratch-resistance, and chemical-resistance may be applied to the object-side surface of first lens L1. In that case, the material of first lens L1 may be plastic. Such a protection means may be a hard coating or a water-repellent coating. If the material of first lens L1 is plastic, when at least one of the surfaces of first lens L1 is an aspheric surface, it is possible to accurately reproduce an aspheric shape, and to produce a lens having excellent performance. Further, it is possible to produce the lens system in light weight and at low cost. Further, it is possible to use an aspheric surface or surfaces at low cost in first lens L1 at which central rays and peripheral rays are most separate, and curvature of field and distortion are easily corrected.

For example, a lens for an in-vehicle camera needs to be resistant to various kinds of shock. Therefore, it is desirable that first lens L1 is thick. It is desirable that the center thickness of first lens L1 is 1.0 mm or more. It is desirable that the center thickness of first lens L1 is 1.1 mm or more to make first lens L1 more shock-resistant.

It is desirable that all of the lenses are made of glass to produce an optical system having excellent environment-resistance. When the optical system is used as a lens for a surveillance camera or a lens for an in-vehicle camera, the optical system may be used in various conditions, such as a wide temperature range from a high temperature to a low temperature and high humidity. It is desirable that all of the lenses are made of glass to produce an optical system having strong resistance to them.

It is desirable that the material of second lens L2 is glass. When glass is used as the material of second lens L2, material having a high refractive index is easily used, and the refractive power of second lens L2 is easily increased. Therefore, an angle of view is easily widened.

The material of third lens L3 may be glass. When the material of third lens L3 is glass, it is possible to suppress a deterioration of performance by temperature change. Further, it is possible to reduce the Abbe number of third lens L3, and to excellently correct a lateral chromatic aberration. Further, when plastic is used as the material of second lens L2 and fourth lens L4, a shift in focus caused by a change in temperature is easily suppressed by using glass as the material of third lens L3.

The material of fourth lens L4 may be glass. When the material of fourth lens L4 is glass, it is possible to suppress a deterioration of performance by temperature change.

It is desirable that the material of second lens L2 and fourth lens L4 is plastic.

When the material of second lens L2 and fourth lens L4 is plastic, it is possible to accurately reproduce an aspheric shape, and to produce a lens having excellent performance. Further, it is possible to produce the lens system in light weight and at low cost.

It is desirable that the material of third lens L3 is plastic. When the material of third lens L3 is plastic, it is possible to accurately reproduce an aspheric shape, and to produce a lens having excellent performance. Further, it is possible to produce the lens system in light weight and at low cost.

As the material of plastic, for example, acrylic, polyolefin-based material, polycarbonate-based material, epoxy resin, PET (Polyethylene terephthalate), PES (Poly Ether Sulphone), polycarbonate, and the like may be used.

As the material of first lens L2, third lens L3 and fourth lens L4, so-called nano-composite material, which is obtained by mixing particles smaller than the wavelength of light into plastic, may be used.

Further, a filter that cuts ultraviolet light to blue light, or an IR (InfraRed) cut filter, which cuts infrared light, may be inserted between the lens system and the imaging device 5 based on the purpose of the imaging lens 1. Alternatively, a coating having a function similar to the filter may be applied to a lens surface, or a material that absorbs ultraviolet light, blue light, infrared light or the like may be used as the material of one of the lenses.

FIG. 1 illustrates a case of arranging optical member PP, which is assumed to be various filters or the like, between a lens system and the imaging device 5.

Alternatively, the various filters may be arranged between the lenses, or a coating having an action similar to various filters may be applied a lens surface of one of the lenses included in the imaging lens.

Here, rays of light passing through the outside of the effective diameter between lenses may become stray light, and reach the image plane, and the stray light may become ghost. Therefore, it is desirable that a light shield means for blocking the stray light is provided, if necessary. The light shield means may be provided, for example, by applying an opaque paint to a portion of a lens in the outside of the effective diameter, or by providing there an opaque plate member. Alternatively, an opaque plate member, as a light shield means, may be provided in the optical path of rays that will become stray light. Alternatively, a hood-like member for blocking stray light may be provided further toward the object side of the lens closest to the object side. As an example, FIG. 1 illustrates an example in which light shield means 11 and 12 are provided in the outside of the effective diameter on the image-side surfaces of first lens L1 and second lens L2, respectively. The positions at which the light shield means are provided are not limited to the example illustrated in FIG. 1. The light shield means may be arranged on other lenses or between lenses.

Further, a member, such as a stop, which blocks peripheral rays in such a manner that relative illumination remains within a practically acceptable range may be arranged between lenses. The peripheral rays are rays from an object point that is not on optical axis Z, and pass through a peripheral portion of an entrance pupil of an optical system. When a member that blocks the peripheral rays is provided in this manner, it is possible to improve the image quality in the peripheral portion of the image formation area. Further, ghost is reducible by blocking, by this member, light that will generate ghost.

Further, it is desirable that the lens system consists of only four lenses of first lens L1, second lens L2, third lens L3, and fourth lens L4. When the lens system consists of only four lenses, the cost of the lens system is reducible.

An imaging apparatus according to an embodiment of the present disclosure includes an imaging lens according to an embodiment of the present disclosure. Therefore, the imaging apparatus is configurable in small size and at low cost, and has a sufficiently wide angle of view, and excellent images with high resolution are obtainable by using an imaging device.

Further, images imaged by imaging apparatuses including the imaging lenses according to the first through third embodiments may be displayed on cellular phones. For example, an imaging apparatus including an imaging lens according to an embodiment of the present disclosure is installed in a car, as an in-vehicle camera, and a rear or surrounding area of the car is imaged by the in-vehicle camera, and images obtained by imaging are displayed on a display device in some cases. In such cases, if a car navigation system (hereinafter, referred to as a car navigation) is installed in a car, images obtained by imaging may be displayed on a display device of the car navigation. However, if no car navigation is installed, a specialized display device, such as a liquid crystal display, needs to be set in the car. However, a display device is expensive. Meanwhile, a high performance display device, on which dynamic images and Web pages are viewable or the like, is mounted on a cellular phone in recent years. When the cellular phone is used as a display device for an in-vehicle camera, even if no car navigation is installed in the car, it is not necessary to install a specialized display device. Consequently, it is possible to install the in-vehicle camera at low cost.

Here, an image imaged by an in-vehicle camera may be sent to a cellular phone through a wire by using a cable or the like. Alternatively, the image may be sent to the cellular phone wirelessly by infrared ray communication or the like. Further, a cellular phone or the like and the operation state of a car may be linked with each other. When the car is switched into reverse gear, or a directional indicator is operated, or the like, an image imaged by the in-vehicle camera may be automatically displayed on the display device of the cellular phone.

The display device on which an image imaged by the in-vehicle camera is displayed is not limited to the cellular phone, but may be a mobile information terminal, such as a PDA, a small personal computer, or a portable small car navigation.

Further, a cellular phone on which an imaging lens of the present disclosure is mounted may be fixed in a car, and used as an in-vehicle camera. Smart phones of recent years have processing performance similar to the performance of a PC. Therefore, a camera of a cellular phone is usable in a similar manner to an in-vehicle camera, for example, by fixing the cellular phone onto a dashboard or the like of the car, and by directing the camera forward. Further, a function for issuing a warning by recognizing white lines and road signs may be provided as an application of a smart phone. Further, a camera may be directed to a driver, and used as a system for issuing a warning when the driver has fallen asleep or looked aside. Alternatively, the cellular phone may be linked with a car, and used as a part of a system for operating a steering wheel. Since a car is kept in a high temperature environment and a low temperature environment, an in-vehicle camera requires strong environment-resistance. When the imaging lens of the present disclosure is mounted on a cellular phone, the cellular phone is taken out from the car and carried by the driver while the car is not driven. Therefore, the environment-resistance of the imaging lens may be lowered. Consequently, it is possible to introduce an in-vehicle system at low cost.

### [Numerical Value Examples of Imaging Lens]

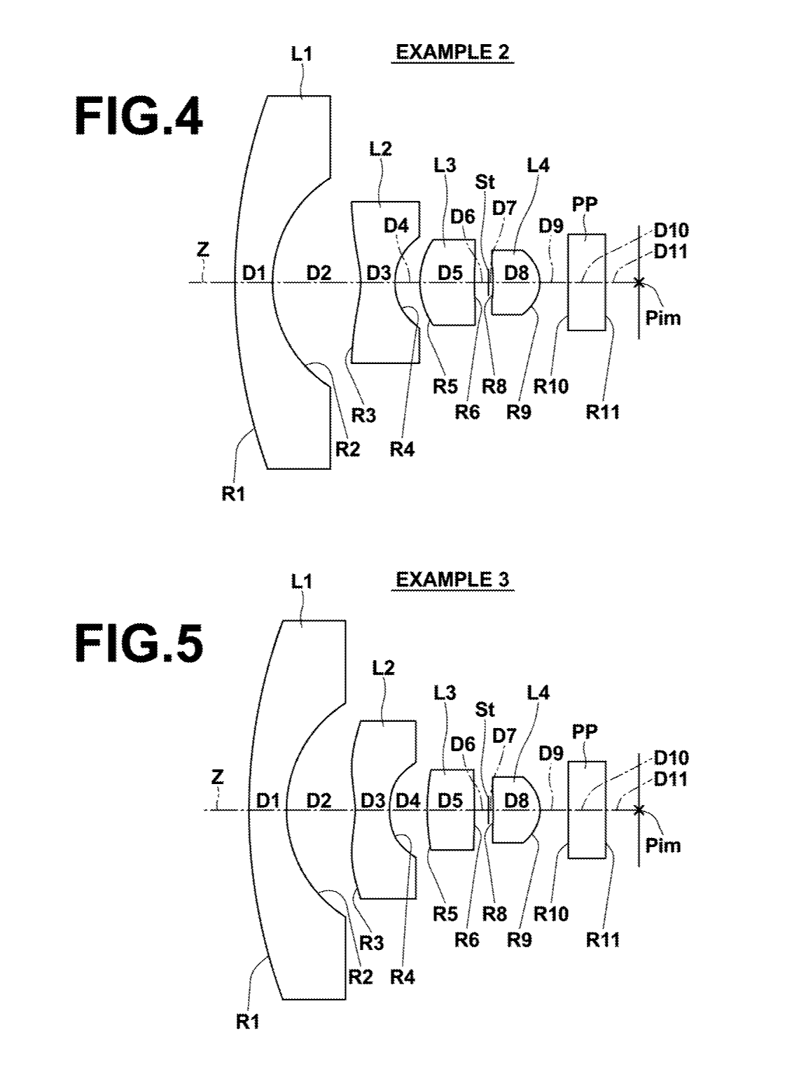

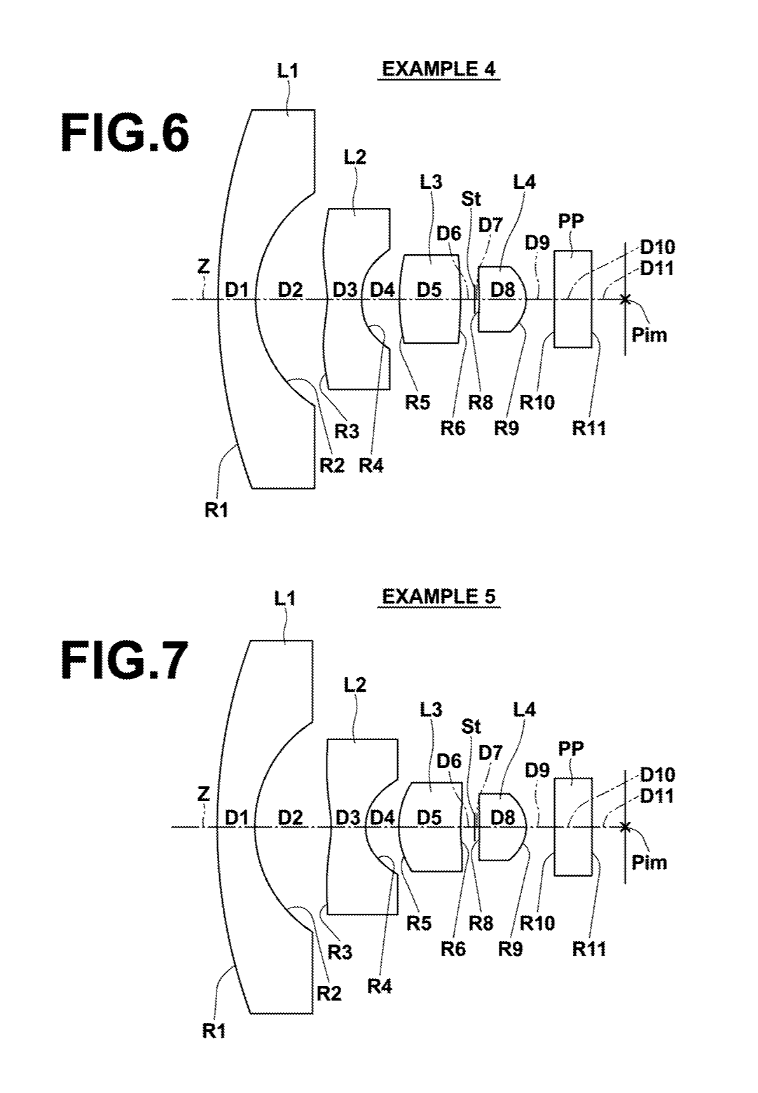

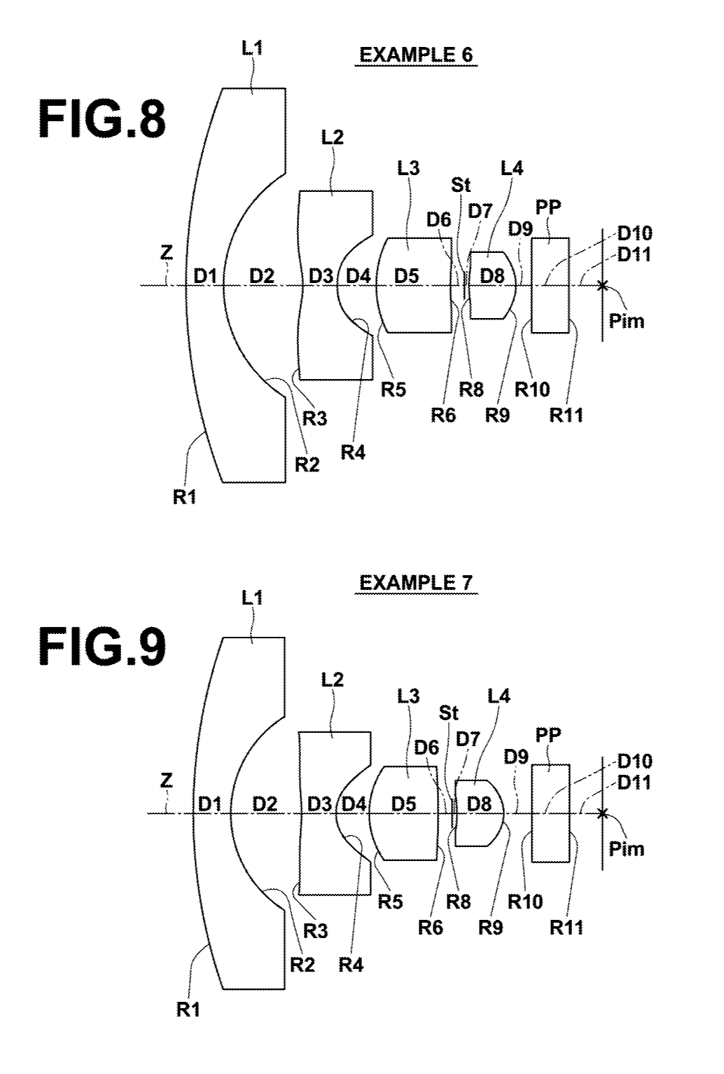

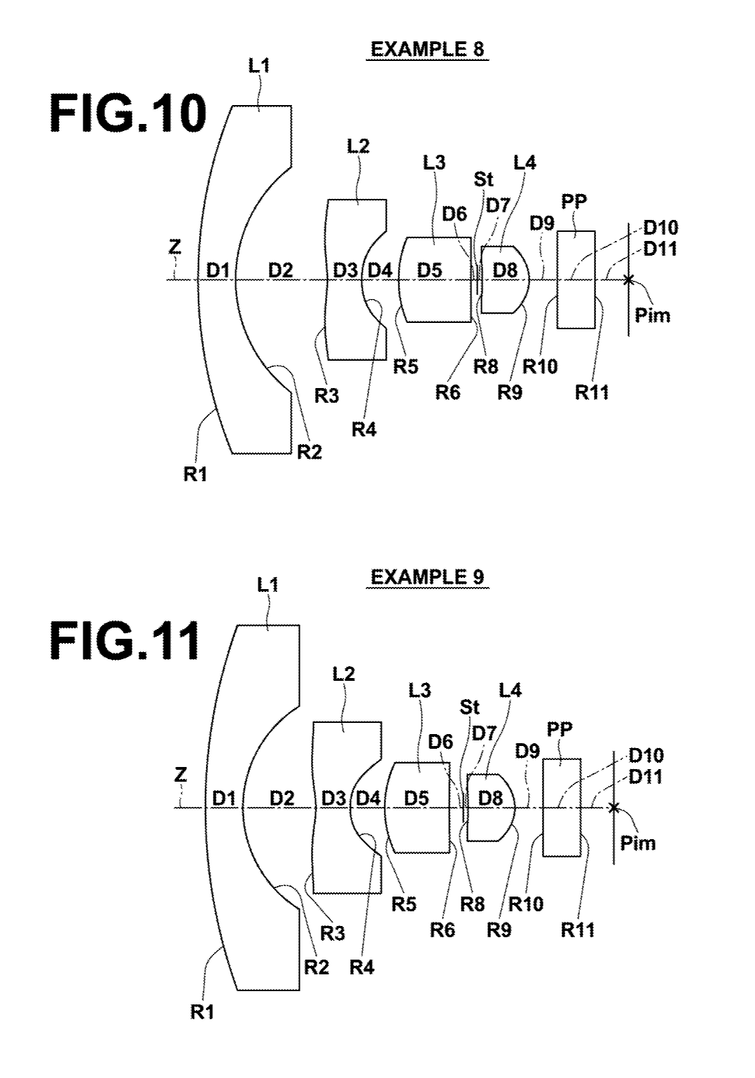

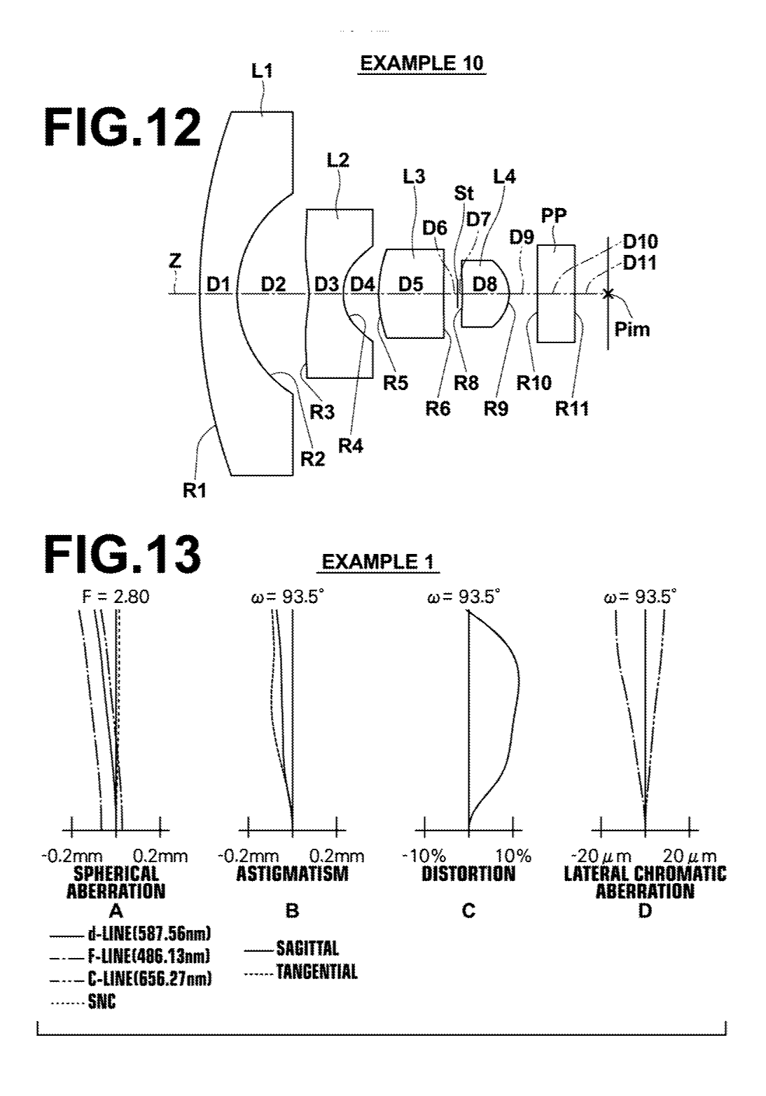

Next, numerical value examples of imaging lenses of the present disclosure will be described. FIG. 3 through FIG. 12 illustrate lens cross sections of imaging lenses of Example 1 through Example 10, respectively. In FIG. 3 through FIG. 12, the left side of the diagram is the object side, and the right side of the diagram is the image side. Further, aperture stop St, optical member PP, and an imaging device 5 arranged at image plane Sim are also illustrated in a similar manner to FIG. 1. In each of the diagrams, aperture stop St does not represent the shape nor the size of the aperture stop, but the position of the aperture stop on optical axis Z. In each example, signs Ri, Di (i=1, 2, 3, . . . ) in the lens cross section correspond to Ri, Di in lens data, which will be described next.

Table 1 through Table 10 show lens data about the imaging lenses of Example 1 through Example 10, respectively. In each table, (A) shows basic lens data, and (B) shows various data, and (C) shows aspherical data.

In the basic lens data, column Si shows the surface number of the i-th surface (i=1, 2, 3, . . . ). The object-side surface of a composition element closest to the object side is the first surface, and surface numbers sequentially increase toward the image side. Column Ri shows the curvature radius of the i-th surface, and column Di shows a distance between the i-th surface and the (i+1)th surface on optical axis Z. Here, the sign of a curvature radius is positive when the shape of a surface is convex toward the object side, and the sign of a curvature radius is negative when the shape of a surface is convex toward the image side. Further, column Ndj shows the refractive index of the j-th optical member (j=1, 2, 3, . . . ) for d-line (wavelength is 587.6 nm). A lens closest to the object side is the first optical member, and the number of j sequentially increases toward the image side. The column vdj shows the Abbe number of the j-th optical element for d-line. Here, the basic lens data include aperture stop St and optical member PP. In the column of surface number, the term (St) is also written for a row of a surface corresponding to aperture stop St. Further, an imaging surface is represented by IMG.

In the basic lens data, mark “*” is attached to the surface number of an aspheric surface. The basic lens data show, as the curvature radius of an aspheric surface, the numerical value of a paraxial curvature radius (a curvature radius at the center). The aspherical data show the surface numbers of aspheric surfaces and aspherical coefficients related to the respective aspheric surfaces. In the numerical values of aspherical data, “E−n” (n: integer) means “×10⁻ⁿ”, and “E+n” means “×10ⁿ”. Further, the aspherical coefficients are coefficients KA, RBm (m=3, 4, 5, . . . 20) in an aspherical expression represented by the following equation:

Zd=C·h²/{1+(1−KA·C²·h²)^{1/2}}+ΣRBm·h^{m}, where

Zd: depth of an aspheric surface (the length of a perpendicular from a point on the aspheric surface at height h to a flat plane that contacts with the vertex of the aspheric surface and is perpendicular to an optical axis),

h: height (a length from the optical axis to a lens surface),

C: the reciprocal of a paraxial curvature radius, and

KA, RBm: aspherical coefficients (m=3, 4, 5, . . . 20).

In various kinds of data, L (in Air) is a length (a back focus portion is an air equivalent length) on optical axis Z from the object-side surface of first lens L1 to image plane Sim, and Bf (in Air) is a length (corresponding to a back focus, an air equivalent length) on optical axis Z from the image-side surface of a lens closest to the image side to image plane Sim, and f is the focal length of the entire system, and f1 is the focal length of first lens L1, and f2 is the focal length of second lens L2, and f3 is the focal length of third lens L3, and f4 is the focal length of fourth lens L4, and f12 is a combined focal length of first lens L1 and second lens L2, and f23 is a combined focal length of second lens L2 and third lens L3, and f34 is a combined focal length of third lens L3 and fourth lens L4, and f123 is a combined focal length of first lens L1, second lens L2, and third lens L3, and f234 is a combined focal length of second lens L2, third lens L3 and fourth lens L4.

Further, Table 11 shows values corresponding to conditional expressions (1) through (17) of each of the examples together. Here, conditional expression (1) is Nd3−Nd2, and conditional expression (2) is D3/f, and conditional expression (3) is D2/f, and conditional expression (4) is R3/f, and conditional expression (5) is vd2−vd3, and conditional expression (6) is vd4−vd3, and conditional expression (7) is (R3+R4)/(R3−R4), and conditional expression (8) is (R5+R6)/(R5−R6), and conditional expression (9) is |f12/f34|, and conditional expression (10) is (D4+D5)/f, and conditional expression (11) is R5/f, and conditional expression (12) is D1/f, and conditional expression (13) is L/f, and conditional expression (14) is (R8+R9)/(R8−R9), and conditional expression (15) is f3/f, and conditional expression (16) is R1/f, and conditional expression (17) is Bf/f, where

Nd2 is a refractive index of the material of second lens L2 for d-line,

Nd3 is a refractive index of the material of third lens L3 for d-line,

vd2 is an Abbe number of the material of second lens L2 for d-line,

vd3 is an Abbe number of the material of third lens L3 for d-line,

vd4 is an Abbe number of the material of fourth lens L4 for d-line,

R1 is a paraxial curvature radius of an object-side surface of first lens L1,

R3 is a paraxial curvature radius of an object-side surface of second lens L2,

R4 is a paraxial curvature radius of an image-side surface of second lens L2,

R5 is a paraxial curvature radius of an object-side surface of third lens L3,

R6 is a paraxial curvature radius of an image-side surface of third lens L3,

R8 is a paraxial curvature radius of an object-side surface of fourth lens L4,

R9 is a paraxial curvature radius of an image-side surface of fourth lens L4,

D1 is a center thickness of first lens L1,

D2 is an air space between first lens L1 and second lens L2,

D3 is a center thickness of second lens L2,

D4 is an air space between second lens L2 and third lens L3,

D5 is a center thickness of third lens L3,

L is a length from a vertex of an object-side surface of first lens L1 to an image plane,

f3 is a focal length of third lens L3,

f12 is a combined focal length of first lens L1 and second lens L2,

f34 is a combined focal length of third lens L3 and fourth lens L4,

f is a focal length of an entire system, and

Bf is a length from a vertex of an image-side surface of fourth lens L4 to an image plane.

As the unit of each numerical value, “mm” is used for length. However, this unit is only an example. Since an optical system is usable by being proportionally enlarged or proportionally reduced in size, other appropriate units may be used.

TABLE 1
EXAMPLE 1
(A)

| Si | Ri | Di | Ndj | νdj |
|---|---|---|---|---|
| 1 | 17.4859 | 1.2000 | 1.77250 | 49.6 |
| 2 | 3.9920 | 2.2828 | | |
| *3 | −2.3839 | 1.1000 | 1.53389 | 56.0 |
| *4 | 2.9772 | 1.2075 | | |
| 5 | 5.9595 | 1.9644 | 1.92286 | 18.9 |
| 6 | −13.9594 | 0.4500 | | |
| 7(St) | ∞ | 0.1500 | | |
| *8 | −8.0233 | 1.5000 | 1.53389 | 56.0 |
| *9 | −1.1403 | 1.5324 | | |
| 10 | ∞ | 0.5000 | 1.51680 | 64.2 |
| 11 | ∞ | 0.9000 | | |
| IMG | | | | |

(B)

| | |
|---|---|
| BF(in Air) | 2.76 |
| L(in Air) | 12.62 |
| f | 0.85 |
| f1 | −6.97 |
| f2 | −2.31 |
| f3 | 4.75 |
| f4 | 2.31 |
| f12 | −1.38 |
| f34 | 2.36 |

(C)

| SUR- | | | | | | | |
|---|---|---|---|---|---|---|---|
| FACE | | | | | | | |
| NUM- | | | | | | | |
| BER | KA | RB3 | RB4 | RB5 | RB6 | RB7 | RB8 |
| 3 | 0.0000000E+00 | 1.3968399E−01 | −1.9784054E−02 | −1.9231116E−03 | −2.6947973E−05 | 8.4661795E−05 | 3.3852813E−05 |
| 4 | 0.0000000E+00 | 4.1040523E−02 | 1.2493562E−01 | −7.5351090E−02 | 8.9770516E−03 | 1.0163174E−02 | 2.1555530E−03 |
| 8 | 0.0000000E+00 | 7.1305762E−02 | −3.3666829E−01 | −1.0019804E+00 | 6.8080871E+00 | −6.5857482E+00 | −1.4660190E+01 |
| 9 | 0.0000000E+00 | 1.3369299E−02 | −5.0284770E−02 | 2.4622972E−02 | −5.0774163E−02 | 5.2687157E−02 | 2.7285007E−02 |

(C)

| SUR- | | | | | | |
|---|---|---|---|---|---|---|
| FACE | | | | | | |
| NUM- | | | | | | |
| BER | RB9 | RB10 | RB11 | RB12 | RB13 | RB14 |
| 3 | 3.7180254E−06 | −1.1205818E−06 | −6.6675033E−07 | −2.5708328E−07 | −3.0582895E−08 | 6.5234649E−09 |
| 4 | −9.2187291E−04 | −1.0870740E−03 | −5.9043533E−04 | −1.5257338E−04 | −2.2548110E−06 | 5.4876587E−05 |
| 8 | −5.8465733E+00 | 5.1929913E+01 | 8.4783752E+01 | −6.2750924E+01 | −2.0970649E+02 | −1.6006387E+02 |
| 9 | −2.6387081E−02 | −4.4664484E−02 | −2.7885601E−02 | 4.6765932E−03 | 2.7575897E−02 | 3.1584008E−02 |

(C)

| SUR- | | | | | | |
|---|---|---|---|---|---|---|
| FACE | | | | | | |
| NUM- | | | | | | |
| BER | RB15 | RB16 | RB17 | RB18 | RB19 | RB20 |
| 3 | 3.7473899E−09 | 2.7927552E−09 | 3.3434366E−10 | −3.9664416E−11 | −1.4004652E−10 | 2.1680029E−11 |
| 4 | 3.7877646E−05 | 3.1778206E−05 | −1.2964210E−06 | −2.7892336E−05 | 1.7181406E−05 | −3.9185466E−06 |
| 8 | 4.9474665E+01 | 1.8214934E+01 | 1.2310168E+03 | 1.6681929E+03 | −5.2266474E+03 | 2.5262856E+03 |
| 9 | 1.8896608E−02 | −1.7957426E−03 | −2.0628648E−02 | −2.6850355E−02 | −1.3516367E−02 | 2.6030091E−02 |

TABLE 2
EXAMPLE 2
(A)

| Si | Ri | Di | Ndj | νdj |
|---|---|---|---|---|
| 1 | 17.5104 | 1.2000 | 1.77250 | 49.6 |
| 2 | 3.9435 | 2.8237 | | |
| *3 | −2.0567 | 1.1000 | 1.53389 | 56.0 |
| *4 | 2.1535 | 0.8000 | | |
| 5 | 2.4220 | 1.7367 | 1.92286 | 18.9 |
| 6 | 9.1232 | 0.4500 | | |
| 7(St) | ∞ | 0.1499 | | |
| *8 | −6.9438 | 1.5000 | 1.53389 | 56.0 |
| *9 | −1.0555 | 0.9000 | | |
| 10 | ∞ | 0.5000 | 1.51680 | 64.2 |
| 11 | ∞ | 1.5337 | | |
| IMG | | | | |

(B)

| | |
|---|---|
| BF(in Air) | 2.76 |
| L(in Air) | 12.52 |
| f | 0.90 |
| f1 | −6.85 |
| f2 | −1.81 |
| f3 | 3.18 |
| f4 | 2.14 |
| f12 | −1.07 |
| f34 | 2.65 |

(C)

| SUR- | | | | | | | |
|---|---|---|---|---|---|---|---|
| FACE | | | | | | | |
| NUM- | | | | | | | |
| BER | KA | RB3 | RB4 | RB5 | RB6 | RB7 | RB8 |
| 3 | 0.0000000E+00 | 1.3266550E−01 | −1.8604030E−02 | −2.1445345E−03 | −7.8161890E−05 | 9.2142655E−05 | 4.2068268E−05 |
| 4 | 0.0000000E+00 | 5.1285939E−02 | 7.2252761E−02 | −6.8028743E−02 | 1.6957819E−02 | 1.3456643E−02 | 2.6512762E−03 |
| 8 | 0.0000000E+00 | 1.0395415E−01 | −3.5543674E−01 | −1.2199567E+00 | 6.8117068E+00 | −6.3703261E+00 | −1.4394485E+01 |
| 9 | 0.0000000E+00 | 3.7542141E−02 | −1.2518545E−01 | 7.3320619E−02 | −3.4868484E−02 | 3.6164503E−02 | 6.2351582E−03 |

(C)

| SUR- | | | | | | |
|---|---|---|---|---|---|---|
| FACE | | | | | | |
| NUM- | | | | | | |
| BER | RB9 | RB10 | RB11 | RB12 | RB13 | RB14 |
| 3 | 6.9426613E−06 | −2.1442167E−07 | −5.4103697E−07 | −2.7853342E−07 | −5.6779583E−08 | −7.0581098E−09 |
| 4 | −1.4163333E−03 | −1.6711592E−03 | −9.6977577E−04 | −3.2848898E−04 | −4.8345277E−05 | 7.3353859E−05 |
| 8 | −5.6032648E+00 | 5.2123799E+01 | 8.4710428E+01 | −6.3835568E+01 | −2.1349191E+02 | −1.6892775E+02 |
| 9 | −3.5959866E−02 | −4.1014319E−02 | −1.6659971E−02 | 1.6448739E−02 | 3.4770188E−02 | 3.2068248E−02 |

(C)

| SUR- | | | | | | |
|---|---|---|---|---|---|---|
| FACE | | | | | | |
| NUM- | | | | | | |
| BER | RB15 | RB16 | RB17 | RB18 | RB19 | RB20 |
| 3 | −3.3052889E−10 | 1.8332617E−09 | 4.6898884E−11 | −2.5691513E−11 | −6.9909574E−11 | 3.9085746E−11 |
| 4 | 4.8019280E−05 | 7.0480417E−05 | 2.2495048E−05 | −1.4537836E−05 | 7.1186432E−06 | −7.7747433E−06 |
| 8 | 3.5012517E+01 | 7.9503635E+00 | 1.2620763E+03 | 1.8136195E+03 | −4.9764636E+03 | 2.0869776E+03 |
| 9 | 1.3311017E−02 | −1.0940759E−02 | −2.9907144E−02 | −3.2562805E−02 | −1.2331710E−02 | 3.6799328E−02 |

TABLE 3
EXAMPLE 3
(A)

| Si | Ri | Di | Ndj | νdj |
|---|---|---|---|---|
| 1 | 17.4813 | 1.2000 | 1.77250 | 49.6 |
| 2 | 4.0368 | 2.1968 | | |
| *3 | −2.3124 | 1.1000 | 1.53389 | 56.0 |
| *4 | 3.6021 | 1.2082 | | |
| 5 | 7.0596 | 1.5100 | 1.92286 | 18.9 |
| 6 | −40.3732 | 0.4500 | | |
| 7(St) | ∞ | 0.1500 | | |
| *8 | −21.8243 | 1.5000 | 1.53389 | 56.0 |
| *9 | −1.1210 | 0.9000 | | |
| 10 | ∞ | 0.5000 | 1.51680 | 64.2 |
| 11 | ∞ | 1.5294 | | |
| IMG | | | | |

(B)

| | |
|---|---|
| BF(in Air) | 2.76 |
| L(in Air) | 12.07 |
| f | 0.85 |
| f1 | −7.07 |
| f2 | −2.48 |
| f3 | 6.61 |
| f4 | 2.16 |
| f12 | −1.48 |
| f34 | 2.20 |

(C)

| SUR- | | | | | | | |
|---|---|---|---|---|---|---|---|
| FACE | | | | | | | |
| NUM- | | | | | | | |
| BER | KA | RB3 | RB4 | RB5 | RB6 | RB7 | RB8 |
| 3 | 0.0000000E+00 | 1.4232045E−01 | −1.7009068E−02 | −1.9233592E−03 | −8.6185564E−05 | 7.3013731E−05 | 3.3607979E−05 |
| 4 | 0.0000000E+00 | 7.1751053E−02 | 9.4878331E−02 | −6.5088162E−02 | 1.6420923E−02 | 1.3094342E−02 | 2.6910185E−03 |
| 8 | 0.0000000E+00 | 5.0526020E−02 | −2.7626820E−01 | −1.0858653E+00 | 6.8703036E+00 | −6.5101531E+00 | −1.4813554E+01 |
| 9 | 0.0000000E+00 | 3.4028647E−02 | −1.1234284E−01 | 7.8679245E−02 | −3.3153740E−02 | 3.5616957E−02 | 4.1739314E−03 |

(C)

| SUR- | | | | | | |
|---|---|---|---|---|---|---|
| FACE | | | | | | |
| NUM- | | | | | | |
| BER | RB9 | RB10 | RB11 | RB12 | RB13 | RB14 |
| 3 | 4.2874469E−06 | −8.9719496E−07 | −6.4191947E−07 | −2.7034173E−07 | −3.8644352E−08 | 2.0310764E−09 |
| 4 | −1.2355604E−03 | −1.5163648E−03 | −8.9507006E−04 | −3.1168355E−04 | −6.0688125E−05 | 4.6753142E−05 |
| 8 | −6.2732650E+00 | 5.1498784E+01 | 8.4930056E+01 | −6.1203362E+01 | −2.0611312E+02 | −1.5484449E+02 |
| 9 | −3.8663575E−02 | −4.3369220E−02 | −1.7931787E−02 | 1.6607507E−02 | 3.6299525E−02 | 3.4600598E−02 |

(C)

| SUR- | | | | | | |
|---|---|---|---|---|---|---|
| FACE | | | | | | |
| NUM- | | | | | | |
| BER | RB15 | RB16 | RB17 | RB18 | RB19 | RB20 |
| 3 | 2.7172059E−09 | 2.6535230E−09 | 3.4135420E−10 | 1.6473088E−12 | −1.2381054E−10 | 2.0054035E−11 |
| 4 | 5.0683836E−05 | 4.8483348E−05 | 9.9577330E−06 | −2.2044681E−05 | 1.5668583E−05 | −6.4707208E−06 |
| 8 | 5.3201290E+01 | 1.2702848E+01 | 1.2039671E+03 | 1.6126456E+03 | −5.2731333E+03 | 2.6712104E+03 |
| 9 | 1.6265871E−02 | −8.2597077E−03 | −2.8080935E−02 | −3.2173292E−02 | −1.3778745E−02 | 3.3233612E−02 |

TABLE 4
EXAMPLE 4
(A)

| Si | Ri | Di | Ndj | νdj |
|---|---|---|---|---|
| 1 | 17.4497 | 1.2000 | 1.77250 | 49.6 |
| 2 | 4.0240 | 2.2911 | | |
| *3 | −2.2979 | 1.1000 | 1.53389 | 56.0 |
| *4 | 3.3130 | 1.2085 | | |
| 5 | 6.2899 | 1.9544 | 1.92286 | 18.9 |
| 6 | −14.2039 | 0.4500 | | |
| 7(St) | ∞ | 0.1500 | | |
| *8 | −9.2387 | 1.5000 | 1.53389 | 56.0 |
| *9 | −1.1520 | 0.9000 | | |
| 10 | ∞ | 0.5000 | 1.51680 | 64.2 |
| 11 | ∞ | 1.5320 | | |
| IMG | | | | |

(B)

| | |
|---|---|
| BF(in Air) | 2.76 |
| L(in Air) | 12.62 |
| f | 0.86 |
| f1 | −7.04 |
| f2 | −2.38 |
| f3 | 4.95 |
| f4 | 2.32 |
| f12 | −1.42 |
| f34 | 2.35 |

(C)

| SUR- | | | | | | | |
|---|---|---|---|---|---|---|---|
| FACE | | | | | | | |
| NUM- | | | | | | | |
| BER | KA | RB3 | RB4 | RB5 | RB6 | RB7 | RB8 |
| 3 | 0.0000000E+00 | 1.3794103E−01 | −1.7468180E−02 | −1.9192797E−03 | −8.1515918E−05 | 7.1950118E−05 | 3.2627076E−05 |
| 4 | 0.0000000E+00 | 6.0301110E−02 | 9.8472428E−02 | −6.8474900E−02 | 1.4078277E−02 | 1.2113359E−02 | 2.4461935E−03 |
| 8 | 0.0000000E+00 | 7.2460783E−02 | −3.2071567E−01 | −1.0857282E+00 | 6.9176913E+00 | −6.4297841E+00 | −1.4727756E+01 |
| 9 | 0.0000000E+00 | 2.7160988E−02 | −1.0074877E−01 | 7.6817059E−02 | −3.4677237E−02 | 3.6140214E−02 | 5.3585804E−03 |

(C)

| SUR- | | | | | | |
|---|---|---|---|---|---|---|
| FACE | | | | | | |
| NUM- | | | | | | |
| BER | RB9 | RB10 | RB11 | RB12 | RB13 | RB14 |
| 3 | 3.9356752E−06 | −9.7581806E−07 | −6.4597505E−07 | −2.6335201E−07 | −3.4062384E−08 | 3.9177381E−09 |
| 4 | −1.2026087E−03 | −1.4219629E−03 | −8.1874024E−04 | −2.6467445E−04 | −3.7998247E−05 | 5.4359049E−05 |
| 8 | −6.2603892E+00 | 5.1330986E+01 | 8.4505814E+01 | −6.1917206E+01 | −2.0698845E+02 | −1.5543812E+02 |
| 9 | −3.7904499E−02 | −4.3306342E−02 | −1.8319965E−02 | 1.6148835E−02 | 3.6063743E−02 | 3.4720424E−02 |

(C)

| SUR- | | | | | | |
|---|---|---|---|---|---|---|
| FACE | | | | | | |
| NUM- | | | | | | |
| BER | RB15 | RB16 | RB17 | RB18 | RB19 | RB20 |
| 3 | 3.3505399E−09 | 2.8525380E−09 | 3.8642824E−10 | 4.0605617E−12 | −1.2820816E−10 | 1.6282437E−11 |
| 4 | 5.2462451E−05 | 4.6742830E−05 | 8.5207741E−06 | −2.3030397E−05 | 1.6312697E−05 | −6.4954084E−06 |
| 8 | 5.3827890E+01 | 1.6003103E+01 | 1.2112896E+03 | 1.6229228E+03 | −5.2687178E+03 | 2.6464155E+03 |
| 9 | 1.6707541E−02 | −7.6383556E−03 | −2.7487163E−02 | −3.1824458E−02 | −1.3870364E−02 | 3.2543187E−02 |

TABLE 5
EXAMPLE 5
(A)

| Si | Ri | Di | Ndj | νdj |
|---|---|---|---|---|
| 1 | 17.2055 | 1.2000 | 1.77250 | 49.6 |
| 2 | 3.9745 | 2.4447 | | |
| *3 | −2.2558 | 1.1000 | 1.53389 | 56.0 |
| *4 | 1.7627 | 1.0646 | | |
| 5 | 2.6140 | 1.9755 | 1.95906 | 17.5 |
| 6 | 6.1333 | 0.4500 | | |
| 7(St) | ∞ | 0.1500 | | |
| *8 | 33.5857 | 1.5000 | 1.53389 | 56.0 |
| *9 | −1.1366 | 0.9000 | | |
| 10 | ∞ | 1.2000 | 1.51680 | 64.2 |
| 11 | ∞ | 1.0681 | | |
| IMG | | | | |

(B)

| | |
|---|---|
| BF(in Air) | 2.76 |
| L(in Air) | 12.64 |
| f | 0.86 |
| f1 | −6.97 |
| f2 | −1.69 |
| f3 | 3.73 |
| f4 | 2.09 |
| f12 | −1.05 |
| f34 | 2.71 |

(C)

| SUR- | | | | | | |
|---|---|---|---|---|---|---|
| FACE | | | | | | |
| NUM- | | | | | | |
| BER | KA | RB3 | RB4 | RB5 | RB6 | RB7 |
| 3 | 0.0000000E+00 | 1.5862430E−01 | −3.3263246E−02 | −1.6876042E−03 | 4.7676082E−04 | 2.2129834E−04 |
| 4 | 0.0000000E+00 | 9.2327413E−03 | 2.1069510E−01 | −1.6884135E−01 | 2.1705639E−02 | 2.5750084E−02 |
| 8 | 0.0000000E+00 | 1.8190772E−02 | 1.3579142E−01 | −1.9549338E+00 | 6.0662207E+00 | −4.9748943E+00 |
| 9 | 0.0000000E+00 | −1.6475732E−02 | 1.5855255E−01 | −2.9696837E−01 | −2.1870731E−02 | 1.9603668E−01 |

(C)

| SUR- | | | | | |
|---|---|---|---|---|---|
| FACE | | | | | |
| NUM- | | | | | |
| BER | RB8 | RB9 | RB10 | RB11 | RB12 |
| 3 | 4.5929533E−05 | −1.4930023E−06 | −3.8562683E−06 | −1.4133768E−06 | −4.2034917E−07 |
| 4 | 5.6660022E−03 | −1.9570447E−03 | −2.3254708E−03 | −6.2242994E−04 | −1.3800293E−03 |
| 8 | −1.1549822E+01 | −5.0207639E+00 | 4.6850386E+01 | 7.3647215E+01 | −7.3722748E+01 |
| 9 | 1.0031991E−01 | −4.7211471E−02 | −1.0997246E−01 | −8.5234387E−02 | −1.8327538E−02 |

(C)

| SUR- | | | | |
|---|---|---|---|---|
| FACE | | | | |
| NUM- | | | | |
| BER | RB13 | RB14 | RB15 | RB16 |
| 3 | −3.4865792E−08 | 1.7983287E−08 | 1.2408062E−08 | 7.8107125E−09 |
| 4 | 4.6811388E−05 | 4.7594533E−04 | −2.0851039E−04 | 5.1272239E−05 |
| 8 | −2.0680188E+02 | −1.2590268E+02 | 1.2236231E+02 | 9.7454714E+01 |
| 9 | 3.8883016E−02 | 6.1258045E−02 | 4.7698237E−02 | 1.2869461E−02 |

(C)

| SUR- | | | | |
|---|---|---|---|---|
| FACE | | | | |
| NUM- | | | | |
| BER | RB17 | RB18 | RB19 | RB20 |
| 3 | 4.3764938E−10 | −6.5133603E−10 | −1.8463388E−10 | 4.4634527E−11 |
| 4 | 1.8550066E−04 | −8.0234180E−06 | −6.7027981E−05 | 1.2360090E−05 |
| 8 | 1.2026729E+03 | 1.3420613E+03 | −5.8039491E+03 | 3.3606210E+03 |
| 9 | −2.5054371E−02 | −4.2935600E−02 | −2.7297513E−02 | 3.5165298E−02 |

TABLE 6
EXAMPLE 6
(A)

| Si | Ri | Di | Ndj | νdj |
|---|---|---|---|---|
| 1 | 17.5191 | 1.2000 | 1.77250 | 49.6 |
| 2 | 4.2235 | 2.5414 | | |
| *3 | −1.8016 | 1.1000 | 1.53389 | 56.0 |
| *4 | 2.7135 | 1.2491 | | |
| 5 | 3.2971 | 2.3704 | 2.14352 | 17.8 |
| 6 | 7.0121 | 0.4500 | | |
| 7(St) | ∞ | 0.1504 | | |
| *8 | 3.6659 | 1.5000 | 1.53389 | 56.0 |
| *9 | −1.3590 | 0.5000 | | |
| 10 | ∞ | 1.2000 | 1.51680 | 64.2 |
| 11 | ∞ | 1.0720 | | |
| IMG | | | | |

(B)

| | |
|---|---|
| BF(in Air) | 2.36 |
| L(in Air) | 12.92 |
| f | 0.86 |
| f1 | −7.50 |
| f2 | −1.87 |
| f3 | 4.06 |
| f4 | 2.07 |
| f12 | −1.17 |
| f34 | 2.65 |

(C)

| SUR- | | | | | | |
|---|---|---|---|---|---|---|
| FACE | | | | | | |
| NUM- | | | | | | |
| BER | KA | RB3 | RB4 | RB5 | RB6 | RB7 |
| 3 | 0.0000000E+00 | 1.9572745E−01 | −3.8061190E−02 | −2.3438893E−03 | 4.5835553E−04 | 2.3094404E−04 |
| 4 | 0.0000000E+00 | 8.0930884E−02 | 1.5258620E−01 | −1.1449043E−01 | 1.9865740E−02 | 1.5918133E−02 |
| 8 | 0.0000000E+00 | −1.3955753E−02 | 2.8577545E−01 | −1.9883916E+00 | 6.1135354E+00 | −4.8761860E+00 |
| 9 | 0.0000000E+00 | 1.7527998E−03 | 1.3871061E−01 | −2.7009919E−01 | 1.1323445E−02 | 2.0238663E−01 |

(C)

| SUR- | | | | | |
|---|---|---|---|---|---|
| FACE | | | | | |
| NUM- | | | | | |
| BER | RB8 | RB9 | RB10 | RB11 | RB12 |
| 3 | 4.9905467E−05 | −3.2522024E−07 | −3.4480406E−06 | −1.3980627E−06 | −4.0673744E−07 |
| 4 | 1.4797036E−03 | −2.3232692E−03 | −1.4495756E−03 | 9.2948351E−05 | −1.1835164E−03 |
| 8 | −1.1832302E+01 | −5.7993749E+00 | 4.6250844E+01 | 7.4611598E+01 | −6.9748712E+01 |
| 9 | 9.3273093E−02 | −5.5254216E−02 | −1.1495117E−01 | −8.6633700E−02 | −1.6662338E−02 |

(C)

| SUR- | | | | |
|---|---|---|---|---|
| FACE | | | | |
| NUM- | | | | |
| BER | RB13 | RB14 | RB15 | RB16 |
| 3 | −3.2811771E−08 | 1.8177361E−08 | 1.1509206E−08 | 7.9097756E−09 |
| 4 | 2.3408175E−04 | 5.0851163E−04 | −2.6276074E−04 | 2.8765057E−05 |
| 8 | −1.9951490E+02 | −1.1766317E+02 | 1.2459816E+02 | 8.1308332E+01 |
| 9 | 4.2460997E−02 | 6.5336413E−02 | 5.0953080E−02 | 1.4450472E−02 |

(C)

| SUR- | | | | |
|---|---|---|---|---|
| FACE | | | | |
| NUM- | | | | |
| BER | RB17 | RB18 | RB19 | RB20 |
| 3 | 2.0446922E−10 | −6.6469417E−10 | −1.7776522E−10 | 4.7847127E−11 |
| 4 | 1.7942018E−04 | −3.0690194E−05 | −7.9354686E−05 | 2.6297712E−05 |
| 8 | 1.1534420E+03 | 1.2583323E+03 | −5.8611483E+03 | 3.5837722E+03 |
| 9 | −2.5458274E−02 | −4.4391641E−02 | −2.8815150E−02 | 3.5176129E−02 |

TABLE 7
EXAMPLE 7
(A)

| Si | Ri | Di | Ndj | νdj |
|---|---|---|---|---|
| 1 | 17.0144 | 1.2000 | 1.77250 | 49.6 |
| 2 | 3.6422 | 2.2666 | | |
| *3 | −2.9493 | 1.1000 | 1.53389 | 56.0 |
| *4 | 1.5194 | 1.0650 | | |
| 5 | 2.5820 | 2.2047 | 1.84666 | 23.8 |
| 6 | −22.9652 | 0.4502 | | |
| 7(St) | ∞ | 0.1500 | | |
| *8 | −5.2358 | 1.4997 | 1.53389 | 56.0 |
| *9 | −1.1730 | 0.9000 | | |
| 10 | ∞ | 1.2000 | 1.51680 | 64.2 |
| 11 | ∞ | 1.0638 | | |
| IMG | | | | |

(B)

| | |
|---|---|
| BF(in Air) | 2.76 |
| L(in Air) | 12.69 |
| f | 0.90 |
| f1 | −6.24 |
| f2 | −1.73 |
| f3 | 2.85 |
| f4 | 2.51 |
| f12 | −1.03 |
| f34 | 2.83 |

(C)

| SUR- | | | | | | | |
|---|---|---|---|---|---|---|---|
| FACE | | | | | | | |
| NUM- | | | | | | | |
| BER | KA | RB3 | RB4 | RB5 | RB6 | RB7 | RB8 |
| 3 | 0.0000000E+00 | 1.5729554E−01 | −4.2498786E−02 | −1.5188962E−03 | 9.1376060E−04 | 2.8261822E−04 | 3.6426100E−05 |
| 4 | 0.0000000E+00 | 1.4000148E−01 | 2.2820662E−02 | −5.8151082E−02 | 1.6076408E−02 | 6.8866866E−03 | −1.6219073E−03 |
| 8 | 0.0000000E+00 | 1.2768405E−02 | −5.3047058E−02 | −1.3870790E+00 | 6.0328004E+00 | −6.1527824E+00 | −1.2021933E+01 |
| 9 | 0.0000000E+00 | −4.8058253E−03 | −3.8525189E−03 | −3.1022967E−02 | −4.6531284E−02 | 7.7915543E−02 | 3.6893550E−02 |

(C)

| SUR- | | | | | | |
|---|---|---|---|---|---|---|
| FACE | | | | | | |
| NUM- | | | | | | |
| BER | RB9 | RB10 | RB11 | RB12 | RB13 | RB14 |
| 3 | −1.0610280E−05 | −6.6289814E−06 | −2.5823574E−06 | −5.0109005E−07 | 6.8827094E−08 | 8.9947695E−08 |
| 4 | −2.6420537E−03 | −1.2814979E−03 | −2.1279849E−04 | 1.4017163E−04 | 2.1361572E−04 | 1.3559697E−04 |
| 8 | −2.6524040E+00 | 5.0811241E+01 | 7.3261525E+01 | −8.6126166E+01 | −2.3177644E+02 | −1.4281145E+02 |
| 9 | −3.5952806E−02 | −6.1390334E−02 | −3.9536491E−02 | 3.7749868E−03 | 3.5965619E−02 | 4.3374470E−02 |

(C)

| SUR- | | | | | | |
|---|---|---|---|---|---|---|
| FACE | | | | | | |
| NUM- | | | | | | |
| BER | RB15 | RB16 | RB17 | RB18 | RB19 | RB20 |
| 3 | 4.4133248E−08 | 1.3774636E−08 | −1.4735490E−09 | −1.5022381E−09 | −1.1774660E−09 | 3.0282262E−10 |
| 4 | 1.2496907E−04 | 3.0288336E−05 | −2.1992140E−05 | −1.4279093E−05 | −5.7765052E−05 | 2.7931032E−05 |
| 8 | 1.6525984E+02 | 2.5592894E+02 | 1.4050604E+03 | 1.1423554E+03 | −6.9545471E+03 | 4.3995461E+03 |
| 9 | 2.7544981E−02 | −1.8525816E−04 | −2.6688439E−02 | −3.6690607E−02 | −1.9445947E−02 | 3.4516065E−02 |

TABLE 8
EXAMPLE 8
(A)

| Si | Ri | Di | Ndj | νdj |
|---|---|---|---|---|
| 1 | 14.6777 | 1.2002 | 1.77250 | 49.6 |
| 2 | 4.5425 | 2.9345 | | |
| *3 | −2.8511 | 1.1000 | 1.53389 | 56.0 |
| *4 | 3.3057 | 1.1815 | | |
| 5 | 3.4998 | 2.3140 | 1.95906 | 17.5 |
| 6 | 29.8258 | 0.2000 | | |
| 7(St) | ∞ | 0.1635 | | |
| *8 | −10.6023 | 1.5000 | 1.53389 | 56.0 |
| *9 | −1.2380 | 0.0000 | | |
| 10 | ∞ | 0.9000 | 1.51680 | 64.2 |
| 11 | ∞ | 1.2000 | | |
| IMG | | | | |

(B)

| | |
|---|---|
| BF(in Air) | 2.77 |
| L(in Air) | 13.36 |
| f | 1.14 |
| f1 | −8.98 |
| f2 | −2.70 |
| f3 | 3.96 |
| f4 | 2.49 |
| f12 | −1.66 |
| f34 | 2.62 |

(C)

| SUR- | | | | | | | |
|---|---|---|---|---|---|---|---|
| FACE | | | | | | | |
| NUM- | | | | | | | |
| BER | KA | RB3 | RB4 | RB5 | RB6 | RB7 | RB8 |
| 3 | 0.0000000E+00 | 1.2619729E−01 | −1.8397981E−02 | −2.4692965E−03 | 7.1537308E−05 | 1.3880073E−04 | 3.9320068E−05 |
| 4 | 0.0000000E+00 | 1.2364416E−01 | 3.1133363E−03 | −2.8318989E−02 | 2.1962194E−02 | 5.7655667E−03 | −2.4798501E−03 |
| 8 | 0.0000000E+00 | −3.4276339E−02 | 2.4960287E−01 | −2.1352456E+00 | 6.4839139E+00 | −4.7323732E+00 | −1.1940418E+01 |
| 9 | 0.0000000E+00 | −2.9814496E−02 | 5.5092844E−02 | −4.3075476E−02 | −9.9272798E−02 | 6.8003605E−02 | 6.9224602E−02 |

(C)

| SUR- | | | | | | |
|---|---|---|---|---|---|---|
| FACE | | | | | | |
| NUM- | | | | | | |
| BER | RB9 | RB10 | RB11 | RB12 | RB13 | RB14 |
| 3 | −1.7533682E−07 | −2.9044781E−06 | −1.6859963E−06 | −3.8492521E−07 | 7.9910991E−10 | 3.5912291E−08 |
| 4 | −2.7382260E−03 | −1.2135592E−03 | −2.4100626E−04 | 1.1423144E−04 | 1.4703489E−04 | 4.3395709E−05 |
| 8 | −5.5565602E+00 | 4.5856727E+01 | 7.0961722E+01 | −7.8643710E+01 | −2.0935752E+02 | −1.1132843E+02 |
| 9 | 3.0921917E−03 | −4.2388776E−02 | −4.6416887E−02 | −1.9766563E−02 | 1.0153131E−02 | 2.6872390E−02 |

(C)

| SUR- | | | | | | |
|---|---|---|---|---|---|---|
| FACE | | | | | | |
| NUM- | | | | | | |
| BER | RB15 | RB16 | RB17 | RB18 | RB19 | RB20 |
| 3 | 2.4939715E−08 | 6.2472171E−09 | 6.2816746E−10 | 8.7176111E−10 | −1.5398774E−09 | 2.7798104E−10 |
| 4 | 5.9645135E−05 | 3.1037640E−05 | 4.2345135E−06 | 2.3543471E−05 | −5.7124694E−05 | 1.8080152E−05 |
| 8 | 1.7901594E+02 | 2.0420055E+02 | 1.2564567E+03 | 9.8585915E+02 | −6.8256493E+03 | 4.6367003E+03 |
| 9 | 2.5655757E−02 | 1.1175237E−02 | −8.3925226E−03 | −2.0772836E−02 | −1.5774556E−02 | 1.6602482E−02 |

TABLE 9
EXAMPLE 9
(A)

| Si | Ri | Di | Ndj | νdj |
|---|---|---|---|---|
| 1 | 17.0850 | 1.2001 | 1.77250 | 49.6 |
| 2 | 3.8220 | 2.3326 | | |
| *3 | −1.9121 | 1.1000 | 1.53389 | 56.0 |
| *4 | 2.5309 | 1.1067 | | |
| 5 | 3.3296 | 2.0629 | 1.95906 | 17.5 |
| 6 | 31.2490 | 0.4500 | | |
| 7(St) | ∞ | 0.1500 | | |
| *8 | −23.6430 | 1.4998 | 1.53389 | 56.0 |
| *9 | −1.2002 | 0.9000 | | |
| 10 | ∞ | 1.2000 | 1.51680 | 64.2 |
| 11 | ∞ | 1.0693 | | |
| IMG | | | | |

(B)

| | |
|---|---|
| BF(in Air) | 2.76 |
| L(in Air) | 12.66 |
| f | 0.88 |
| f1 | −6.63 |
| f2 | −1.88 |
| f3 | 3.75 |
| f4 | 2.31 |
| f12 | −1.14 |
| f34 | 2.61 |

(C)

| SUR- | | | | | | | |
|---|---|---|---|---|---|---|---|
| FACE | | | | | | | |
| NUM- | | | | | | | |
| BER | KA | RB3 | RB4 | RB5 | RB6 | RB7 | RB8 |
| 3 | 0.0000000E+00 | 2.0645576E−01 | −4.3419650E−02 | −3.1272097E−03 | 6.4597970E−04 | 3.0243167E−04 | 6.0213174E−05 |
| 4 | 0.0000000E+00 | 1.4667047E−01 | 5.2728915E−02 | −4.3565844E−02 | 1.4652457E−02 | 2.6426367E−03 | −3.8091855E−03 |
| 8 | 0.0000000E+00 | −3.3229618E−02 | 2.5962349E−01 | −2.2023301E+00 | 6.3876023E+00 | −4.6070186E+00 | −1.1387267E+01 |
| 9 | 0.0000000E+00 | −2.5894047E−02 | 4.2521069E−02 | −3.7310529E−02 | −8.5053656E−02 | 6.7247802E−02 | 5.6463137E−02 |

(C)

| SUR- | | | | | | |
|---|---|---|---|---|---|---|
| FACE | | | | | | |
| NUM- | | | | | | |
| BER | RB9 | RB10 | RB11 | RB12 | RB13 | RB14 |
| 3 | −2.9341860E−06 | −5.4825584E−06 | −2.5815751E−06 | −6.2058396E−07 | 2.8210356E−09 | 5.9191489E−08 |
| 4 | −3.0119801E−03 | −9.6316180E−04 | 1.1265251E−04 | 3.9811024E−04 | 2.8768540E−04 | 8.8756665E−05 |
| 8 | −5.1152044E+00 | 4.5338714E+01 | 6.8679057E+01 | −8.2299857E+01 | −2.1193072E+02 | −1.0758160E+02 |
| 9 | −9.5093500E−03 | −4.7089328E−02 | −4.2672799E−02 | −1.1417125E−02 | 1.8298510E−02 | 3.1432382E−02 |

(C)

| SUR- | | | | | | |
|---|---|---|---|---|---|---|
| FACE | | | | | | |
| NUM- | | | | | | |
| BER | RB15 | RB16 | RB17 | RB18 | RB19 | RB20 |
| 3 | 3.4708205E−08 | 1.0298568E−08 | 1.0361432E−09 | 1.9389954E−10 | −1.8259403E−09 | 3.6626392E−10 |
| 4 | 5.3786024E−05 | −7.9673189E−07 | −2.5153457E−05 | 6.3411501E−06 | −5.8806667E−05 | 2.6975022E−05 |
| 8 | 1.9487459E+02 | 2.3134480E+02 | 1.2728115E+03 | 9.3705173E+02 | −6.9685396E+03 | 4.7689582E+03 |
| 9 | 2.5448031E−02 | 7.0905295E−03 | −1.4162565E−02 | −2.5420811E−02 | −1.6575118E−02 | 2.1909668E−02 |

TABLE 10
EXAMPLE 10
(A)

| Si | Ri | Di | Ndj | νdj |
|---|---|---|---|---|
| 1 | 17.1928 | 1.2001 | 1.75500 | 52.3 |
| 2 | 3.7782 | 2.2991 | | |
| *3 | −1.9974 | 1.1000 | 1.53389 | 56.0 |
| *4 | 2.5138 | 1.1344 | | |
| 5 | 4.0224 | 2.0753 | 2.15400 | 17.2 |
| 6 | 28.5248 | 0.4501 | | |
| 7(St) | ∞ | 0.1498 | | |
| *8 | −21.9217 | 1.5000 | 1.53389 | 56.0 |
| *9 | −1.1835 | 0.9000 | | |
| 10 | ∞ | 1.2000 | 1.51680 | 64.2 |
| 11 | ∞ | 1.0681 | | |
| IMG | | | | |

(B)

| | |
|---|---|
| BF(in Air) | 2.76 |
| L(in Air) | 12.67 |
| f | 0.88 |
| f1 | −6.67 |
| f2 | −1.92 |
| f3 | 3.88 |
| f4 | 2.29 |
| f12 | −1.17 |
| f34 | 2.54 |

(C)

| SUR- | | | | | | | |
|---|---|---|---|---|---|---|---|
| FACE | | | | | | | |
| NUM- | | | | | | | |
| BER | KA | RB3 | RB4 | RB5 | RB6 | RB7 | RB8 |
| 3 | 0.0000000E+00 | 2.0261375E−01 | −4.3172580E−02 | −3.1956006E−03 | 6.3877720E−04 | 3.0833115E−04 | 6.2288839E−05 |
| 4 | 0.0000000E+00 | 1.5071756E−01 | 4.6137071E−02 | −4.2715323E−02 | 1.4745286E−02 | 1.9804276E−03 | −4.2890621E−03 |
| 8 | 0.0000000E+00 | −3.5109849E−02 | 2.7504484E−01 | −2.2693356E+00 | 6.4538071E+00 | −4.4552219E+00 | −1.1424161E+01 |
| 9 | 0.0000000E+00 | −2.7593724E−02 | 4.5584454E−02 | −3.8033089E−02 | −8.6804389E−02 | 6.6602573E−02 | 5.7439471E−02 |

(C)

| SUR- | | | | | | |
|---|---|---|---|---|---|---|
| FACE | | | | | | |
| NUM- | | | | | | |
| BER | RB9 | RB10 | RB11 | RB12 | RB13 | RB14 |
| 3 | −2.8783590E−06 | −5.5526329E−06 | −2.7664385E−06 | −6.6899414E−07 | −1.4258938E−08 | 6.2397830E−08 |
| 4 | −3.1580926E−03 | −8.9682271E−04 | 2.1701273E−04 | 4.5470225E−04 | 3.3477602E−04 | 1.0860698E−04 |
| 8 | −5.5280302E+00 | 4.4756307E+01 | 6.8635491E+01 | −8.0874449E+01 | −2.0875682E+02 | −1.0445172E+02 |
| 9 | −7.9571791E−03 | −4.6131013E−02 | −4.2839338E−02 | −1.2373882E−02 | 1.7170623E−02 | 3.0670801E−02 |

(C)

| SUR- | | | | | | |
|---|---|---|---|---|---|---|
| FACE | | | | | | |
| NUM- | | | | | | |
| BER | RB15 | RB16 | RB17 | RB18 | RB19 | RB20 |
| 3 | 4.1967417E−08 | 1.3160714E−08 | 1.4253111E−09 | −8.3239081E−10 | −1.7134280E−09 | 3.7817554E−10 |
| 4 | 3.4956648E−05 | 1.9336589E−09 | −4.3364128E−05 | −1.2319231E−06 | −4.9038638E−05 | 2.6200922E−05 |
| 8 | 1.9296883E+02 | 2.1819855E+02 | 1.2513523E+03 | 9.3969775E+02 | −6.8892612E+03 | 4.7156532E+03 |
| 9 | 2.5328305E−02 | 7.5833161E−03 | −1.3353365E−02 | −2.4695971E−02 | −1.6420570E−02 | 2.1096867E−02 |

TABLE 11

| | CONDITIONAL EXPRESSION | | | | | |
|---|---|---|---|---|---|---|
| | (1) | | | | (5) | (6) |
| | Nd3 − | (2) | (3) | (4) | νd2 − | νd3 − |
| EXAMPLE | Nd2 | D3/f | D2/f | R3/f | νd3 | νd4 |
| 1 | 0.39 | 1.30 | 2.69 | −2.81 | 37.10 | 37.10 |
| 2 | 0.39 | 1.22 | 3.12 | −2.27 | 37.10 | 37.10 |
| 3 | 0.39 | 1.29 | 2.57 | −2.70 | 37.10 | 37.10 |
| 4 | 0.39 | 1.28 | 2.68 | −2.68 | 37.10 | 37.10 |
| 5 | 0.43 | 1.28 | 2.85 | −2.63 | 38.50 | 38.50 |
| 6 | 0.61 | 1.28 | 2.96 | −2.10 | 38.20 | 38.20 |
| 7 | 0.31 | 1.22 | 2.51 | −3.26 | 32.20 | 32.20 |
| 8 | 0.43 | 0.96 | 2.57 | −2.50 | 38.50 | 38.50 |
| 9 | 0.43 | 1.26 | 2.66 | −2.18 | 38.50 | 38.50 |
| 10 | 0.62 | 1.25 | 2.61 | −2.27 | 38.80 | 38.80 |

| | CONDITIONAL EXPRESSION | | | | | |
|---|---|---|---|---|---|---|
| | (7) | (8) | (9) | (10) | | |
| | (R3 + R4)/ | (R5 + R6)/ | \|f12/ | (D4 + | (11) | (12) |
| EXAMPLE | (R3 − R4) | (R5 − R4) | f34\| | D5)/f | R5/f | D1/f |
| 1 | −0.11 | −0.40 | 0.07 | 3.74 | 7.03 | 1.41 |
| 2 | −0.02 | −1.72 | 0.10 | 2.80 | 2.68 | 1.33 |
| 3 | −0.22 | −0.70 | 0.22 | 3.18 | 8.26 | 1.40 |
| 4 | −0.18 | −0.39 | 0.08 | 3.69 | 7.34 | 1.40 |
| 5 | 0.12 | −2.49 | 0.21 | 3.54 | 3.04 | 1.40 |
| 6 | −0.20 | −2.78 | 0.20 | 4.22 | 3.84 | 1.40 |
| 7 | 0.32 | −0.80 | 0.06 | 3.62 | 2.86 | 1.33 |
| 8 | −0.07 | −1.27 | 0.02 | 3.06 | 3.06 | 1.05 |
| 9 | −0.14 | −1.24 | 0.08 | 3.62 | 3.80 | 1.37 |
| 10 | −0.11 | −1.33 | 0.10 | 3.65 | 4.57 | 1.36 |

| | CONDITIONAL EXPRESSION | | | | |
|---|---|---|---|---|---|
| | | (14) | | | |
| | (13) | (R8 + R9)/ | (15) | (16) | (17) |
| EXAMPLE | L/f | (R8 − R9) | f3/f | R1/f | Bf/f |
| 1 | 14.88 | 1.33 | 5.60 | 20.62 | 3.26 |
| 2 | 13.84 | 1.36 | 3.51 | 19.36 | 3.05 |
| 3 | 14.12 | 1.11 | 7.73 | 20.45 | 3.23 |
| 4 | 14.73 | 1.28 | 5.78 | 20.37 | 3.22 |
| 5 | 14.73 | 0.93 | 4.34 | 20.04 | 3.21 |
| 6 | 15.05 | 0.46 | 4.73 | 20.41 | 2.75 |
| 7 | 14.04 | 1.58 | 3.16 | 18.82 | 3.05 |
| 8 | 11.70 | 1.26 | 3.47 | 12.85 | 2.42 |
| 9 | 14.45 | 1.11 | 4.28 | 19.50 | 3.15 |
| 10 | 14.41 | 1.11 | 4.41 | 19.55 | 3.14 |

### [Aberration Performance]

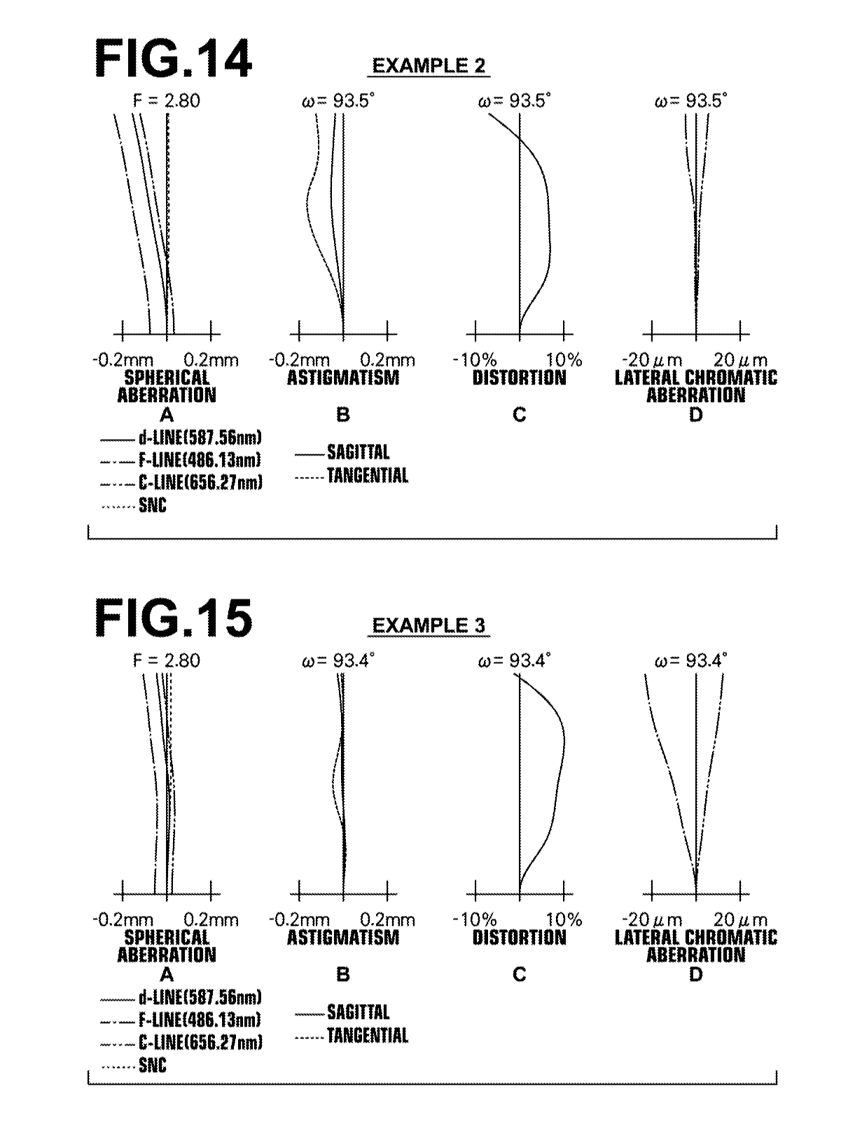

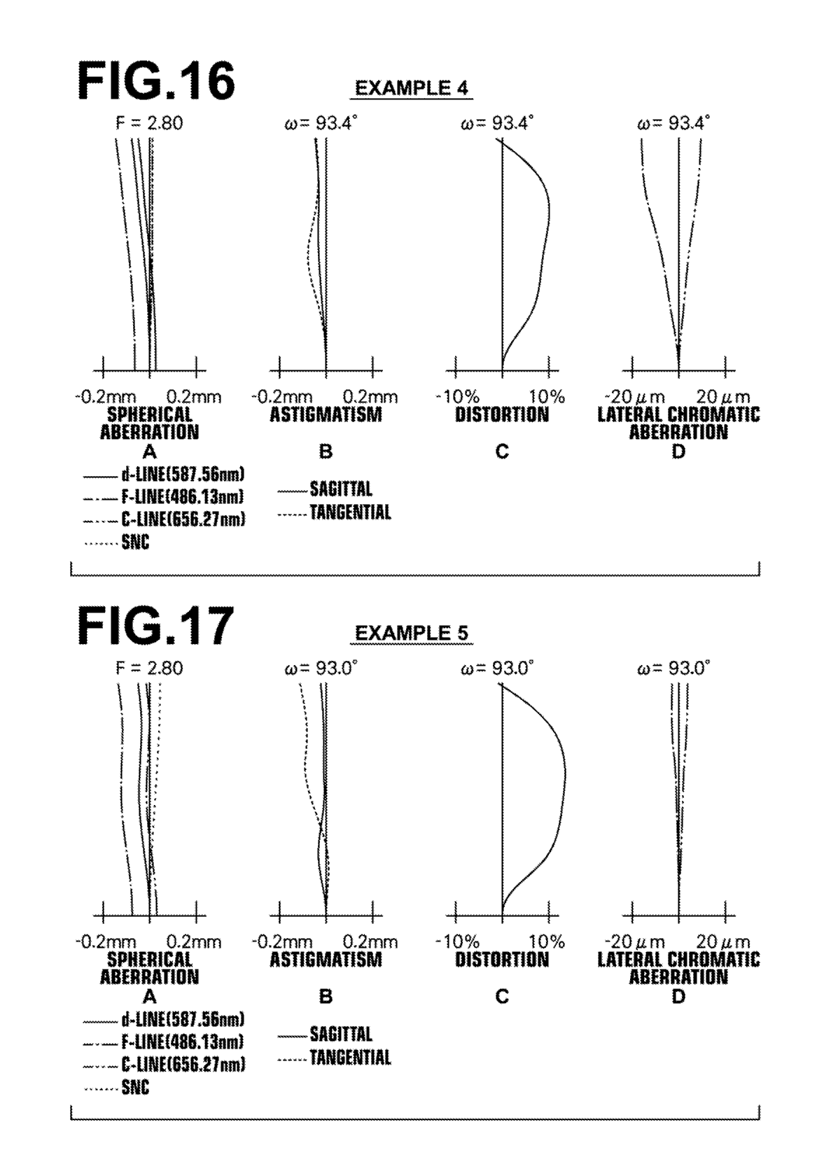

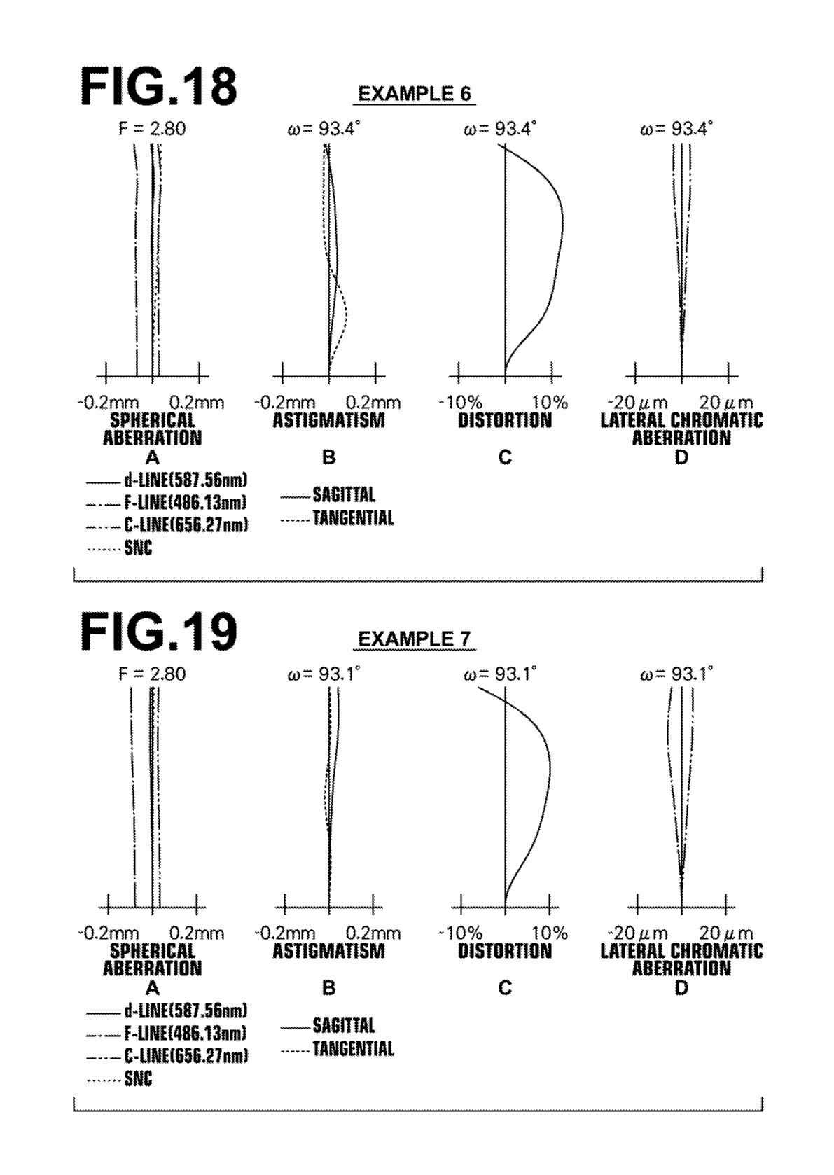

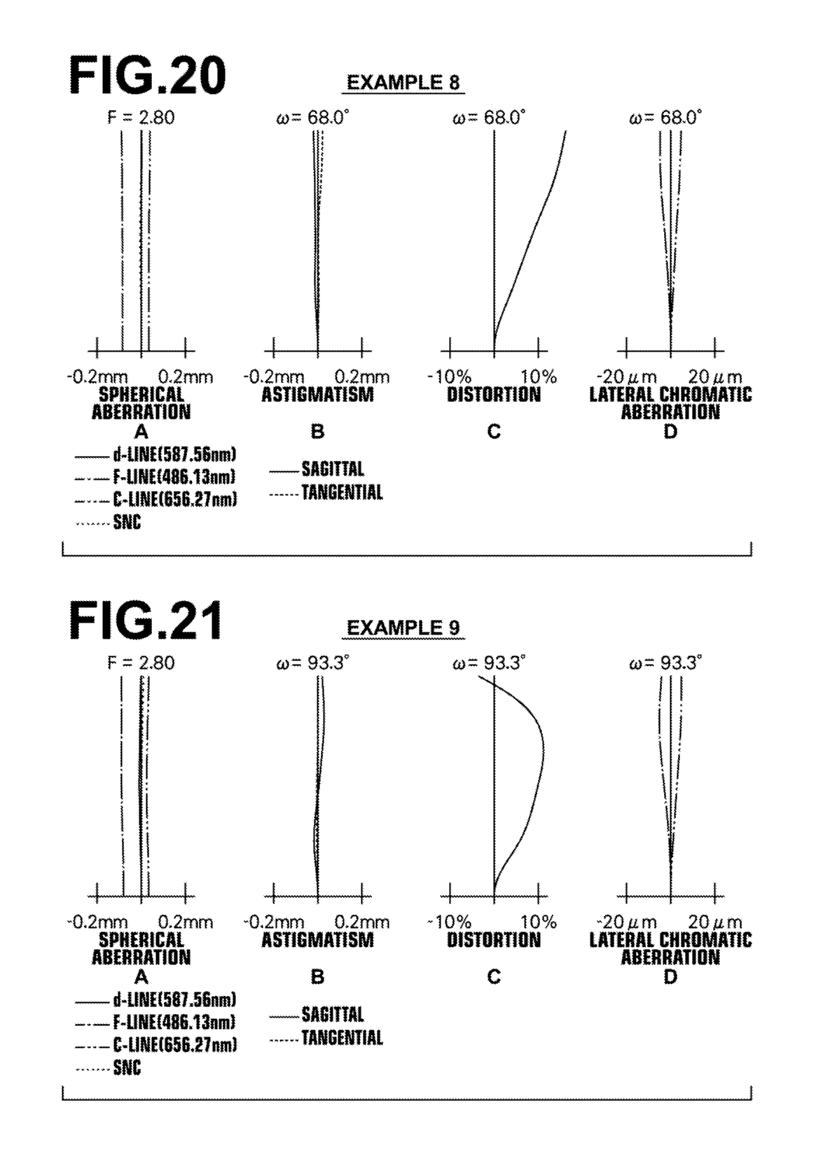

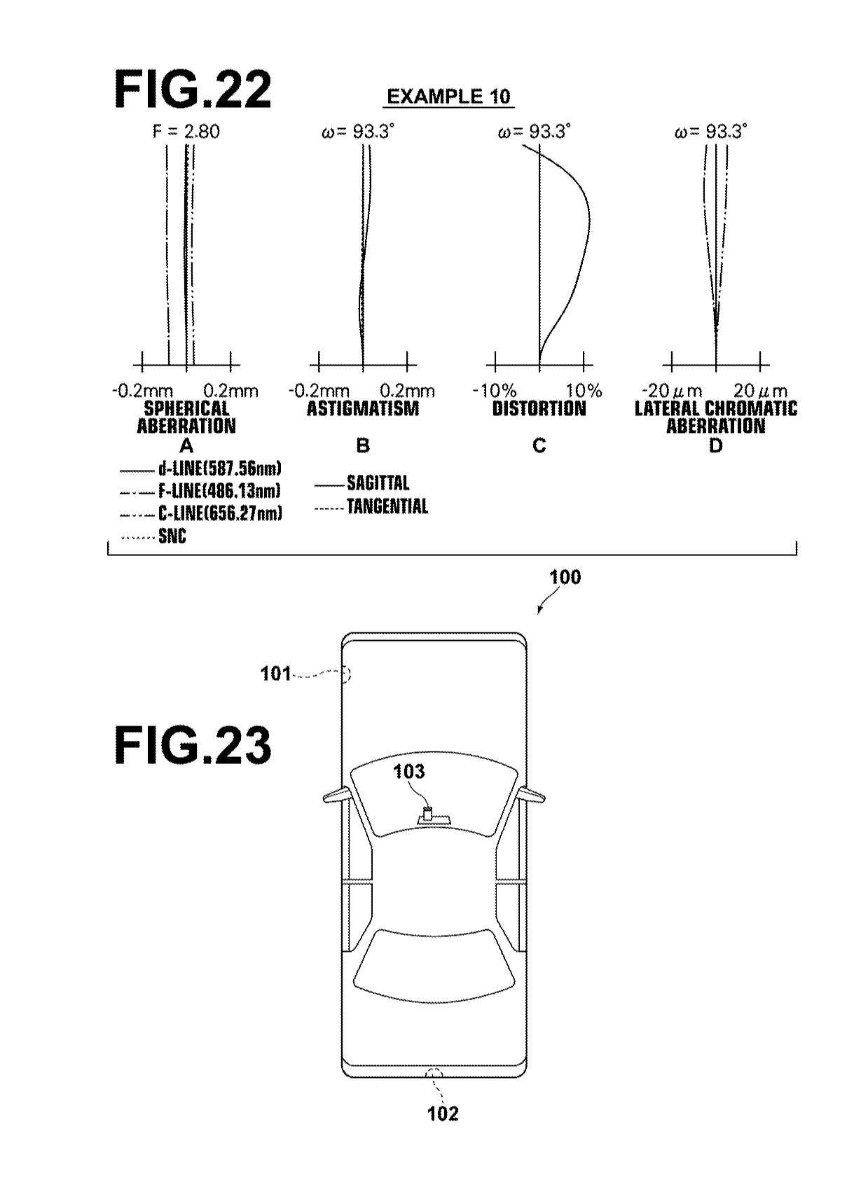

FIG. 13, Sections A through D, FIG. 14, Sections A through D, FIG. 15, Sections A through D, FIG. 16, Sections A through D, FIG. 17, Sections A through D, FIG. 18, Sections A through D, FIG. 19, Sections A through D, FIG. 20, Sections A through D, FIG. 21, Sections A through D, and FIG. 22, Sections A through D are aberration diagrams of the imaging lenses in Examples 1 through 10, respectively.

Here, the aberration diagrams of Example 1 will be explained as an example, but the aberration diagrams of the other examples are similar to those of Example 1. FIG. 13, Section A, Section B, Section C and Section D illustrate a spherical aberration, astigmatism, distortion, and a lateral chromatic aberration of the imaging lens of Example 1, respectively. In the spherical aberration diagram, F represents an F-number, and in the other diagrams, to represents a half angle of view. The diagram of distortion illustrates a shift amount from an ideal image height 2f×tan(φ/2), which is represented by using focal length f of the entire system and angle φ of view (used as a variable, 0≦φ≦ω). Each aberration diagram illustrates an aberration when d-line (wavelength 587.56 nm) is a reference wavelength. The spherical aberration diagram illustrates aberrations also for F-line (wavelength 486.13 nm), C-line (wavelength 656.27 nm), and an offense against the sine condition (represented as SNC). Further, the diagram of a lateral chromatic aberration illustrates aberrations for F-line and C-line. Since the line types used in the lateral chromatic aberration diagram are the same as those used in the spherical aberration diagram, descriptions of the line types will be omitted.

As these data show, each of the imaging lenses of Examples 1 through 10 consists of four lenses, which are a small number of lenses, and is producible in small size and at low cost. Further, a wider angle of view of 136 to 187 degrees is achievable, and the F-number is 2.8, which is small, and the imaging lenses have excellent optical performance in which each of the aberrations is excellently corrected. These imaging lenses are appropriate for use in a surveillance camera, an in-vehicle camera for imaging the front, the lateral sides, the rear or the like of a car and the like.

### [Embodiment of Imaging Apparatus]

FIG. 23 illustrates, as an example of use, a manner of installing imaging apparatuses including imaging lenses according to embodiments of the present disclosure in a car 100. In FIG. 23, the car 100 includes an exterior camera 101 for imaging a driver's blind spot toward a side of a seat next to the driver, an exterior camera 102 for imaging a driver's blind spot toward the rear of the car 100, and an interior camera 103 for imaging the same range as the driver's visual field. The interior camera 103 is attached to the back side of a rearview mirror. The exterior camera 101, the exterior camera 102, and the interior camera 103 are imaging apparatuses according to embodiments of the present disclosure, and they include imaging lenses according to embodiments of the present disclosure and imaging devices for converting optical images formed by the imaging lenses into electrical signals.

The imaging lenses according to the embodiments of the present disclosure have the aforementioned advantages. Therefore, the exterior cameras 101 and 102, and the interior camera 103 are configurable in small size and at low cost. They have wide angles of view, and excellent images are obtainable even in a peripheral portion of an image formation area.

So far, the present disclosure has been described by using embodiments and examples. However, the present disclosure is not limited to the aforementioned embodiments nor examples, and various modifications are possible. For example, values of a curvature radius, a distance between surfaces, a refractive index, and an Abbe number of each lens element are not limited to the values in the aforementioned numerical value examples, but may be other values.

In the aforementioned examples, all of the lenses are made of homogeneous material. Alternatively, a refractive index distribution type lens or lenses may be used. Further, in some of the aforementioned examples, second lens L2 through fourth lens L4 consist of refraction-type lenses having aspheric surfaces, but a diffraction optical element or elements may be formed on one or plural surfaces.

In the embodiment of the imaging apparatus, a case in which the present disclosure is applied to an in-vehicle camera is illustrated in the drawing and described. However, use of the present disclosure is not limited to this purpose. For example, the present disclosure may be applied to a camera for a mobile terminal, a surveillance camera, and the like.

What is claimed is:

1. An imaging lens consisting of, in order from the object side:
a first lens having negative refractive power;
a second lens having negative refractive power;
a third lens having positive refractive power; and
a fourth lens having positive refractive power,
wherein the following conditional expressions are satisfied:
0.22<Nd3−Nd2 (1);
1.2<D3/f (2); and
−0.4<(R3+R4)/(R3−R4)<1.0 (7-5), where
Nd3 is a refractive index of the material of the third lens for d-line,
Nd2 is a refractive index of the material of the second lens for d-line,
D3 is a center thickness of the second lens,
f is a focal length of an entire system,
R3 is a paraxial curvature radius of an object-side surface of the second lens, and
R4 is a paraxial curvature radius of an image-side surface of the second lens.

2. An imaging lens consisting of, in order from the object side:
a first lens having negative refractive power;
a second lens having negative refractive power;
a third lens having positive refractive power; and
a fourth lens having positive refractive power,
wherein the following conditional expressions are satisfied:
0.22<Nd3−Nd2 (1);
2.5<D2/f<4.5 (3);
30.0<vd2−vd3 (5);
−0.4<(R3+R4)/(R3−R4)<1.0 (7-5); and
0.46<(R8+R9)/(R8−R9)<3.0 (14-5), where
Nd3 is a refractive index of the material of the third lens for d-line,
Nd2 is a refractive index of the material of the second lens for d-line,
D2 is an air space between the first lens and the second lens,
f is a focal length of an entire system,
vd2 is an Abbe number of the material of the second lens for d-line,
vd3 is an Abbe number of the material of the third lens for d-line,
R3 is a paraxial curvature radius of an object-side surface of the second lens,
R4 is a paraxial curvature radius of an image-side surface of the second lens,
R8 is a paraxial curvature radius of an object-side surface of the fourth lens, and
R9 is a paraxial curvature radius of an image-side surface of the fourth lens.

3. An imaging lens consisting of, in order from the object side:
a first lens having negative refractive power;
a second lens having negative refractive power;
a third lens having positive refractive power; and
a fourth lens having positive refractive power,
wherein the following conditional expressions are satisfied:
0.22<Nd3−Nd2 (1);
−3.3<R3/f<−1.4 (4); and
−10.0<(R5+R6)/(R5−R6)<−0.2 (8-5), where
Nd3 is a refractive index of the material of the third lens for d-line,
Nd2 is a refractive index of the material of the second lens for d-line,
R3 is a paraxial curvature radius of an object-side surface of the second lens,
f is a focal length of an entire system,
R5 is a paraxial curvature radius of an object-side surface of the third lens, and
R6 is a paraxial curvature radius of an image-side surface of the third lens.

4. The imaging lens, as defined in claim 1, wherein the third lens has a plano-convex shape with its convex surface facing the object side or a positive meniscus shape with its convex surface facing the object side.

5. The imaging lens, as defined in claim 1, wherein the fourth lens has a plano-convex shape with its convex surface facing the image side or a positive meniscus shape with its convex surface facing the image side.

6. The imaging lens, as defined in claim 1, wherein the following conditional expression is satisfied:
30.0<vd4−vd3 (6), where
vd4 is an Abbe number of the material of the fourth lens for d-line, and
vd3 is an Abbe number of the material of the third lens for d-line.

7. The imaging lens, as defined in claim 1, wherein the following conditional expression is satisfied:
0.0<|f12/f34|<1.0 (9), where
f12 is a combined focal length of the first lens and the second lens, and
f34 is a combined focal length of the third lens and the fourth lens.

8. The imaging lens, as defined in claim 1, wherein the following conditional expression is satisfied:
2.0<(D4+D5)/f<6.0 (10), where
D4 is an air space between the second lens and the third lens, and
D5 is a center thickness of the third lens.

9. The imaging lens, as defined in claim 1, wherein the following conditional expression is satisfied:
0.5<R5/f<15.0 (11), where
R5 is a paraxial curvature radius of an object-side surface of the third lens, and
f is a focal length of an entire system.

10. The imaging lens, as defined in claim 1, wherein the following conditional expression is satisfied:
0.8<D1/f<3.0 (12), where
D1 is a center thickness of the first lens.

11. The imaging lens, as defined in claim 1, wherein the following conditional expression is satisfied:
10.0<L/f<20.0 (13), where
L is a length from a vertex of an object-side surface of the first lens to an image plane, and
f is a focal length of an entire system.

12. The imaging lens, as defined in claim 1, wherein the following conditional expression is further satisfied:
0.25<Nd3−Nd2<0.7 (1-4), where
Nd3 is a refractive index of the material of the third lens for d-line, and
Nd2 is a refractive index of the material of the second lens for d-line.

13. The imaging lens, as defined in claim 1, wherein the following conditional expression is further satisfied:
1.2<D3/f<1.8 (2-3), where
D3 is a center thickness of the second lens, and
f is a focal length of an entire system.

14. The imaging lens, as defined in claim 2, wherein the following conditional expression is further satisfied:
2.5<D2/f<3.5 (3-2), where
D2 is an air space between the first lens and the second lens, and
f is a focal length of an entire system.

15. The imaging lens, as defined in claim 3, wherein the following conditional expression is further satisfied:
−3.3<R3/f<−1.9 (4-2), where
R3 is a paraxial curvature radius of an object-side surface of the second lens, and
f is a focal length of an entire system.

16. The imaging lens, as defined in claim 2, wherein the following conditional expression is further satisfied:
32.0<vd2−vd3 (5-1), where
vd2 is an Abbe number of the material of the second lens for d-line, and
vd3 is an Abbe number of the material of the third lens for d-line.

17. The imaging lens, as defined in claim 2, wherein the following conditional expression is further satisfied:
35.0<vd2−vd3 (5-2), where
vd2 is an Abbe number of the material of the second lens for d-line, and
vd3 is an Abbe number of the material of the third lens for d-line.

18. The imaging lens, as defined in claim 6, wherein the following conditional expression is further satisfied:
32.0<vd4−vd3 (6-1), where
vd3 is an Abbe number of the material of the third lens for d-line, and
vd4 is an Abbe number of the material of the fourth lens for d-line.

19. The imaging lens, as defined in claim 3, wherein the following conditional expression is further satisfied:
−5.0<(R5+R6)/(R5−R6)<−0.2 (8-2), where
R5 is a paraxial curvature radius of an object-side surface of the third lens, and
R6 is a paraxial curvature radius of an image-side surface of the third lens.

20. An imaging apparatus comprising:
the imaging lens, as defined in claim 1, which is mounted thereon.
